(19) United States
(12) Patent Application Publication
(10) Pub. No.: US 2011/0078074 A1
(43) Pub. Date: Mar. 31, 2011

(54) SYSTEMS, METHODS, AND MEDIA FOR INDUSTRY RESOURCE MANAGEMENT AND CONTRACT MANAGEMENT

(76) Inventor: Craig S. Lipman, Yardley, PA (US)

(21) Appl. No.: 12/894,518

(22) Filed: Sep. 30, 2010

Related U.S. Application Data
(60) Provisional application No. 61/247,036, filed on Sep. 30, 2009.

(51) Int. Cl. G06Q 10/00; G06Q 90/00; G06Q 40/00

(52) U.S. Cl. 705/39; 705/500; 705/1.1; 705/347; 705/307

(57) ABSTRACT

Embodiments of the subject invention are directed to a contract monitoring system or a method for contract monitoring. In an embodiment, a contract monitoring system monitors compliance with a contract. The system receives contract terms and event messages, which describe performance of the contract terms, and presents performance information to the parties to the contract. In an embodiment, the performance information is analyzed with regard to the contract terms. In an embodiment, such performance analysis is used to generate one or more performance measures for evaluating a party to the contract. In an embodiment, such performance analysis is used to generate a settlement statement for the contract. In an embodiment, the contract monitoring system reports information regarding resources registered with the system. In an embodiment, the contract monitoring system can be used to store, generate, and/or present resource, settlement, performance, and/or event information related to a plurality of organizations.

### CROSS-REFERENCE TO A RELATED APPLICATION

This application claims the benefit of U.S. provisional application Ser. No. 61/247,036, filed Sep. 30, 2010, which is incorporated herein by reference in its entirety.

### BACKGROUND OF INVENTION

Every year, theft of mobile or off-road construction, industrial and related equipment (“equipment”) such as generators, aerial work platforms, and backhoes costs North American companies up to one billion dollars per year in direct and indirect costs. The value of stolen equipment has increased 20% annually since 1996 according to the United States-based Insurance Services Office, Inc. Once stolen, the recovery rate for equipment is typically only 10-15%. In contrast, according to the FBI's Uniform Crime Report for 2000, the recovery rate for on-road vehicles is 62%. Part of the problem is the difficulty in identifying stolen equipment at jobsites or in the used or resale equipment market. As the likelihood of detecting stolen equipment decreases, the rewards for thieves, their success potential, and hence equipment theft itself, increases.

An additional problem exists in ensuring that equipment is properly serviced and maintained. For example, equipment is often rented from third-party suppliers. The project owners and the contractors using the equipment therefore have limited knowledge regarding the rented equipment including, for example, its maintenance history. Moreover, there is often no easy way to check or augment the equipment's service records from the jobsite.

Vehicle registration systems for on-road vehicles have been around for almost as long as automobiles. Related patents go back to at least 1920 (U.S. Pat. No. 1,495,549 to Coleman) and include the capturing of vehicle and ownership information, the issuance of registration paperwork, and application of a visual indicator or tag to a registered vehicle. Visual indicators, or tags, can take various forms, for example a decal on the vehicle's license plate and/or windshield. The indicators are often “perishable” in that they expire and must be renewed periodically. It is intentionally easy to identify a vehicle with an expired tag and difficult to renew the vehicle's registration without proof of ownership. Some government jurisdictions incorporate safety and other requirements into their vehicle registration processes. For example, it is not uncommon to encounter requirements for proof of motor vehicle insurance or a vehicle safety inspection as pre-requisites to vehicle registration. But such comprehensive, government-mandated registries do not exist for off-road vehicles or other equipment.

Private registries do exist for equipment, but these registration systems lack a perishable visual indicator and other features of government-mandated registries for on-road vehicles. For example, the National Equipment Registry, Inc. (NER) maintains an equipment registry used to return recovered equipment to its registered owner after a theft. Law enforcement, after locating potentially stolen equipment, may contact NER who then provides ownership information (provided the owner previously registered the equipment with NER). While private equipment registries, like NER, aid in the return of stolen equipment, these registries lack mechanisms to identify stolen equipment in the field. In addition, NER provides no functionality related to validating compliance with manufacturer recalls, service notifications, safety or other requirements. Various equipment manufacturers maintain private registries which incorporate ownership information as well as recall, service, and other safety information, but these registries do not generally include visual indicators beyond the equipment's model and serial numbers. These static numbers give no visual indication of the equipment's current status.

Existing registries also lack the ability to track the current location of equipment. Government-mandated registries for on-road vehicles may include information regarding the state or county where a vehicle was purchased or registered, but this information is not updated when the vehicle moves. Secured neighborhoods, parking lots, and other organizations may register vehicles and track their comings and goings from a particular location. These private registries may capture vehicle ownership information and sometimes include use of a visible registration sticker or even electronic devices such as radio frequency identification (RFID) devices. But these systems are not integrated and therefore can only track whether a particular vehicle is inside a particular facility.

Safety Management Systems (SMSs) exist that help a company manage Safety and Other Requirements (SORs) related to its equipment or other assets. SMSs generally gather information about resources (e.g., people, equipment, materials), gather information about SORs (such as the name, originator, effective dates, and content or instructions), and evaluate the organization's compliance to the SORs. SMSs may be able to track the location of various company resources; however, these systems are limited in that they are not integrated with outside sources of information. SMS systems are built for use by single companies. They therefore do not incorporate information on equipment owned or managed by other parties. Moreover, they are not made to be accessed by persons outside the company. Further, existing SMSs evaluate SOR compliance at a single point in time. They may be able to identify a particular resource that is out of compliance with a particular SOR at a particular point in time, but they are unable to evaluate the resource's compliance with the SOR over a range of time. In addition, they are unable to quantify the non-conformities over the range of time.

Some rental companies have rental business systems for managing their rental processes including the maintenance of customer information, equipment inventory, rental orders, invoicing, and collections. But such systems are incapable of tracking information across rental companies. Nor do they provide an interface or moderator between suppliers and their customers. Such a moderator is needed as one or both parties to such contracts often require financial adjustments at the time an invoice is generated, although such adjustments are rarely agreed to at the time of performance failure.

While the rental lifecycle has administrative differences across rental companies, it has the same general record-generating components. Each lifecycle begins with an order followed by a delivery and ends with an off-rent instruction and a reverse delivery (or off-rent pick-up). During the lifecycle there may be equipment failures and corresponding resolutions, each of which ideally are recorded/documented. There are also invoices that may occur during the life cycle (depending upon the length of the rental) and a final invoice at the close of the rental lifecycle. There is also some type of a (typically ad-hoc) dispute resolution process to address invoice disputes that typically involve either invoice errors or customer complaints raised in opposition to paying all or part of an invoice.

Each rental company typically has its own specialized Contract Management System (CMS) for managing its rental equipment and rental contacts. Each company's CMS captures much of the same type of information. For orders there is data that identifies, inter alia, the customer, the equipment requirements, delivery location/time, and pricing information. The CMS also stores actual delivery information and has failure tracking capabilities. Additionally, there are, of course, invoices—at least one or potentially several depending upon the length of the rental.

Some larger rental customers attempt to standardize their rental lifecycle. For example, an electric utility company that rents $10 million in rental equipment a year may go through a request for proposal (RFP) process that defines how their rental process is to be administered. They create their own standard to which the bid-winning rental company (or companies) must comply. These large rental customers likely have their own CMS that they use to manage a multitude of contacts (rental and otherwise).

While it is not difficult for any one rental company to analyze rental transactions and performance across all of their customers, there is no effective solution when there are multiple rental companies and multiple rental customers.

Thus, a system is needed that integrates ownership, location, safety, and/or other information regarding resources across companies. Equipment is highlighted here as an illustrative example of a type of resource that would benefit from the invention. The subject invention can also be applied to other types of resources including people, materials, funds, and real property, among other resources.

### BRIEF SUMMARY

The present invention provides systems, methods, and media for maintaining and managing resources, as well as for managing contracts so as to document and improve performance under the contracts. Systems for contract dispute resolution are also provided. Through the use of the contract management systems of the current invention, resource allotment and performance can be improved.

In one aspect of the subject invention, a data structure for storing information about mobile resources is provided. The data structure may have, for example, one or more fields identifying an owner of a resource and one or more fields identifying a physical location of the resource. The data structure can also include one or more fields describing the resource's compliance with a requirement, such as a safety, financial, or emissions requirement. The data structure may also store various relationships between organizations and resources in the data structure. For example, the data structure may store a relationship between a resource and its owner, manufacturer, lessee, and/or lessor. In a further embodiment, organizations are granted access to information in the data structure based on these stored relationships.

In another aspect of the subject invention, a system for maintaining and/or managing resources is provided that can include, for example, a database, a data entry module, a query module, and a visual indicator or tag. In one embodiment, the tag is attached to a resource represented in the database, the data entry module is used to enter data related to the resource, and the query module is used to obtain information related to the resource. In a further embodiment, a status indicator is also attached to the resource that presents information obtained from the database. In a specific embodiment, the status indicator presents information related to the resource's compliance with a requirement, such as a safety or maintenance requirement.

In yet another embodiment of the subject invention, a method of maintaining and/or managing resources is provided. The method can include, for example, registering a resource in a database, affixing a tag to the resource, wherein the tag provides a unique identifier for the resource, pulling information about the resource from the database using the unique identifier, comparing the information pulled with other available information about the resource, identifying any inconsistency between the information pulled and the other available information, and noting the identified inconsistency. The inconsistency may be, for example, the resource's noncompliance with a requirement and/or conflicting ownership information for the resource. A status indicator may be used to present information about the inconsistency. The subject invention further provides a system for registration of mobile equipment.

This system establishes and integrates registered work areas within which equipment is registered in a database. Such registered work areas can be bounded in various ways, including non-physical boundaries. For example, the areas may represent equipment used at a particular worksite, equipment used on a specific project or contract, or some other organization of equipment. In one embodiment, equipment owned, leased, and/or managed by different companies or business units is registered in the database. The system can also function to monitor the registered equipment's compliance with one or more requirements. An area steward, such as a construction site superintendent, can be assigned to monitor compliance for all equipment associated with a particular registered work area.

In one embodiment of the subject invention, an equipment monitoring system is provided that is capable of managing, tracking, and communicating a status of resources, such as mobile equipment. The status can include, for example, a safety status, a location status, a financial status, an environmental status, and/or an ownership status. In one embodiment, the monitoring system creates and integrates a plurality of (a) work area registrations, (b) equipment registrations, (c) equipment registration identifiers, (d) equipment status indicators, and (e) equipment ownership records to deter equipment theft, aid in recovery of equipment that was stolen, and improve operational safety of the equipment.

Further embodiments of the subject invention provide a contract monitoring system and a method for contract monitoring. The contract monitoring system can act as a neutral moderator that receives, stores, and presents performance information between the parties to a contract. In one embodiment, the performance information is analyzed with regard to the contract terms. Such performance analysis can be used to generate one or more performance measures for evaluating a party to the contract. The performance analysis can be used to generate a settlement statement (or invoice) for the contract. In one embodiment, the contract monitoring system can be used to store, generate, and/or present resource, settlement, performance, and/or event information related to a plurality of organizations.

### BRIEF DESCRIPTION OF THE DRAWINGS

FIG. 1 provides a high-level context diagram of a system of the subject invention.

FIG. 2 illustrates a Unified Modeling Language (UML) actor diagram of a system showing names and relationships among organizations and people in accordance with one embodiment of the subject invention.

FIG. 3 illustrates a UML use case diagram of a system of the subject invention.

FIG. 4 illustrates a UML class diagram of a system in accordance with the subject invention.

FIG. 5 illustrates a subset of the diagram of FIG. 4 focusing on the Organization class and some of its attributes.

FIG. 6 illustrates a subset of the diagram of FIG. 4 focusing on the Equipment class and some of its attributes.

FIG. 7 illustrates another subset of the diagram of FIG. 4 focusing on the Equipment class and some of its attributes.

FIG. 8 illustrates a subset of the diagram of FIG. 4 focusing on the SOR class and some of its attributes.

FIGS. 8A-B are flowcharts illustrating methods for evaluating compliance with a requirement according to embodiments of the subject invention.

FIG. 9 illustrates a subset of the diagram of FIG. 4 focusing on the Subscription class and some of its attributes.

FIG. 10 is a flowchart illustrating a method of sharing data between trading partners.

FIG. 10A is a flowchart illustrating a method of managing resources.

FIG. 11 is a block diagram illustrating an example application of a contract monitoring system.

FIG. 12 is a functional block diagram of a contract monitoring system according to one embodiment of the subject invention.

FIG. 13 illustrates a UML class diagram of a contract monitoring system in accordance with the subject invention.

FIGS. 14A-B are flowcharts illustrating methods of managing performance events in accordance with the subject invention.

### DETAILED DISCLOSURE

The present invention provides systems, methods, and media for maintaining and/or managing resources as well as for managing contracts.

Systems for Maintaining and/or Managing Resources

In one aspect of the subject invention, a system for maintaining and/or managing resources is provided including a database, a data entry module, a query module, and a visual indicator or tag. In one embodiment, the tag is attached to a resource that is registered with the database.

The data entry module can be used to enter data related to the tagged resource, and the query module can be used to obtain information related to the resource. A status indicator can also be attached to the tagged resource that presents information obtained from the database. In one embodiment, the status indicator changes to display the current status of the tagged resource. Alternatively, the status indicator can present an identifying code that can be used to look up information about the tagged resource in the database. The status indicator can present information related to, for example, the tagged resource's compliance with a requirement, such as a safety requirement.

In one embodiment, the database includes emissions data for various types, classes, or models of resources stored in the database. Such emissions data can include run time, fuel consumption, or other information that quantifies how much a particular resource has been used. Emissions data can also include rate information that specifies how much of a particular pollutant is emitted by the resource per quantum of use. In one embodiment, the query module can pull emissions data for all resources at a selected location.

In another embodiment, a system for registration of mobile equipment is provided that establishes and integrates registered work areas within which equipment is registered in a database. Such registered work areas can be bounded in various ways, including non-physical boundaries. For example, the areas may represent equipment used at a particular location, equipment used on a specific project or contract, or some other organization of equipment. In one embodiment, a work area mandates the registration of equipment entering or used in the area.

The system can also function to monitor the registered equipment's compliance with one or more SORs. Compliance with SORs can be monitored, for example, over a continuous date range. The system can identify all periods of noncompliance with a particular SOR during the specified date range. The system could monitor compliance with location-specific, company-specific, owner-specific, area-specific, worksite-specific, or other customized SORs.

Credential templates can be used to describe what is required to comply with SORs. When a credential is discovered that matches the credential template associated with a requirement, the credential can be evaluated to determine compliance with the associated requirement. In one embodiment, customized SORs, credential templates, and credentials are shared across companies or business units, thus saving each company or business unit the time and effort of independently defining requirements and/or credentials. An area steward, such as a construction site superintendent or other person, can be assigned to monitor compliance for equipment associated with a particular registered work area.

Thus, in one aspect of the subject invention, an equipment monitoring system is provided that is capable of managing, tracking, and communicating a status of resources, such as mobile equipment. The status may be, for example, a safety status, location status, financial status, environmental status, and ownership status. In one embodiment, the monitoring system creates and integrates a plurality of (a) work area registrations, (b) equipment registrations, (c) equipment registration identifiers, (d) equipment status indicators, and/or (e) equipment ownership records to deter equipment theft, aid in recovery of equipment that was stolen, and improve operational safety of the equipment.

Equipment entering a registered work area can be registered (if not already registered), thus creating an equipment registration for each equipment unit. The equipment registration identifiers can be attached to the equipment indicating that the equipment has been registered. Various devices can be used to identify equipment in this manner, such as numbered stickers, decals, radio frequency identifiers (RFIDs), identification cards, and engraved or stenciled lettering, among other possible devices. In a further embodiment, safety status is derived from safety records provided in response to a query based upon an equipment identifier or other criteria. The system can also integrate organization registrations describing persons with various relationships to registered resources. Registered organizations may be, but are not limited to, rental companies, contractors that own or lease equipment, manufacturers, servicers, trade organizations, standard setting organizations, or other industry groups, and government agencies, among other interested persons. In one embodiment, the system provides differentiated access to information based on the identity of a person accessing the system and/or the person's relationship to the information to be accessed.

Such a system can be used by manufacturers to direct its equipment service notifications. Interested parties can leverage such a registration system to communicate Safety and Other Requirements (SORs) that would increase adoption of such a registration system, thereby improving the anti-theft benefits of the system. Furthermore, jobsite owners, superintendents, or others can require use of such a system thereby creating mandatory registrations that deter theft and increase the confidence in equipment compliance with manufacturer safety and reliability recommendations or requirements. As use of the system increases, it may result in both (a) the registration of additional equipment and (b) the updating of registration information for previously registered equipment. Equipment rental companies can use such a system to both validate their equipment compliance to manufacturer requirements and to demonstrate such compliance to current and prospective customers.

Methods of Maintaining and/or Managing Resources

In another aspect of the subject invention, a method of maintaining and/or managing resources is provided. The method generally corresponds to the system described above and can include, for example, registering a resource in a database, affixing a tag to the resource, wherein the tag provides a unique identifier for the resource, pulling information about the resource from the database using the unique identifier, comparing the information pulled with other available information about the resource, identifying an inconsistency between the information pulled and the other available information, and noting the identified inconsistency.

In one embodiment, the inconsistency is the resource's noncompliance with a requirement. In another embodiment, the inconsistency pertains to conflicting ownership information for the resource. In a further embodiment, a status indicator is provided and used to present information about the inconsistency. The information can be presented audibly, visually, via radio frequency transmission, and/or by other signaling methods.

Data Structures for Storing Information about Industry Resources

In one aspect of the current invention, a data structure for storing information about resources is provided. In a specific embodiment, the resources are mobile resources. The data structure can include one or more fields identifying an owner of a resource and one or more fields identifying a physical location of the resource. The data structure may also include one or more fields describing the resource's compliance with a requirement, such as safety, financial, emissions, or other requirement related to the resource.

The data structure may also include data representing one or more areas. Areas can be defined by agreements, worksites, or other physical or organizational boundaries. In one embodiment, the data structure stores associations between areas and resources used in the areas. In a further embodiment, an area steward responsible for maintaining resources used in an area is identified. The area steward may, for example, monitor the resources' compliance with one or more requirements.

The requirements may come from the area, a worksite where the resource is used, a contract, one or more parties to such a contract, the resource's manufacturer, government regulations or statutes, trade or other industry associations, among other sources.

In one embodiment, the data structure stores various relationships between organizations and resources. For example, the data structure can store a relationship between a resource and its owner, manufacturer, lessee, lessor, among other persons. The data structure can also store a relationship between a resource and a party responsible for maintaining the resource or promulgating requirements related to the resource, a party to an agreement related to an area associated with the resource, or a party with some other relationship of interest to the resource. In one embodiment, organizations are granted access to information in the data structure based on these stored relationships. For example, an area steward can be granted access to information about resources intended to be used in the area steward's area.

### Contract Monitoring

In further embodiments the subject invention provides systems, methods, and media for contract monitoring. In specific examples, the subject invention provides methods and systems for monitoring performance under contacts. In preferred embodiments, companies, such as rental companies, that have a plurality of contracts to monitor would engage an organization that then implements the contract monitoring system of the current invention.

In one embodiment of the subject invention, contracts are registered with the contract monitoring system or method. Contracts can be associated with various master or service level agreements. Contracts can be broken down into orders associated with the same area. Orders are further broken down into one or more line items. Each line item is related to a performance obligation of a party under the contract. Each line item is related to a single resource needed for contract performance (e.g., fulfilling the order). In a particular embodiment, the contract is a rental contract, each order is specific to a particular area, and each line item is specific to a particular equipment unit in the particular area (e.g., to be delivered to the particular area).

Such contracts, orders, or line items can be described in terms of various data objects. Each order is assigned an identifying number. The order number can be generated by the contract monitoring system and is provided by the party responsible for fulfilling the order (e.g., the supplier) or by the party responsible for placing the order (e.g., the customer). A contract record includes identifying information for the contracting parties. A contract, order, or line item record includes a description of the obligations of the parties under the contract. Such obligations can be described as SORs with associated credential templates as described above. When performance events occur credentials can be generated and compared to the associated credential templates to analyze performance of the corresponding obligation. In another embodiment, contract obligations can be compared directly to performance events to analyze performance.

Parties to such contracts can be registered with a registry. Such registration entails the provision of various information about the party organization. For example, various information such as tax id numbers and Dunn and Bradstreet numbers can be collected to identify the organization. Alternatively, the contract monitoring system can assign its own unique identifier to an organization. An organization can be described as having various roles. Such roles can be associated with various areas, models, classes, equipment units, or other organizational boundaries. Various other information about contracting parties can also be received, presented, and/or stored.

When an organization wants to use a contract monitoring system the organization can register parties it contracts with as trading partners in an associated registry (if the parties are not already registered with the associated registry). For example, a rental company can register one or more of its customers as a trading partner. Before a contract monitoring system can monitor a contract, all parties to the contract can be registered. Alternatively, a contract monitoring system can monitor some aspects of the contract even if all of the parties to the contract are not registered with an associated registry.

In one embodiment, when an organization is registered only as a trading partner, the organization cannot access any of the data stored on the registry until the organization itself registers. The trading partner registration is then linked to the new registration. Multiple trading partner registrations can exist for the same organization. For example, multiple rental companies may have registered the same rental customer with a registry.

When an organization wants to use a contract monitoring system the organization can also register other objects needed for performance of the contract in an associated registry (if the objects are not already registered with the associated registry). For example, a rental company can register its equipment. Such a registration can include data that uniquely identifies a registered equipment unit. The registration can also include the equipment make, model (and sub-model), manufacturer serial number, company identifier (e.g., many companies paint their own ID number onto each equipment unit), etc. The registration can also identify any modification made relative to the standard make/model, e.g., converted from LP to diesel. An equipment make and model can be separately registered so that the information can be reused.

In one embodiment, an area related to a contract is also registered with an associated registry. Areas can be defined by physical boundaries, agreements, or other organizational boundaries. Areas can be used to monitor performance for all or a subset of contracts or resources within those designations. An organization can define and register its own areas. For example, a site steward may want to monitor all equipment at his site regardless of rental company or customer. Such area definitions can overlap. For example, two organizations can each have their own definitions of the same agreement or physical location. In this case, standardization can be encouraged. Two organizations can also define different areas related to the same order. For example, one organization may want to monitor the contract's performance as part of a particular internal business objective, while another organization may want to include the same contract in a summary analysis related to a physical location.

Ideally, the organization responsible for particular data is the steward of that data. For example, the manufacturer can be responsible for populating all of its equipment information. Other companies can then access the already-validated equipment information. A site or project owner can be responsible for populating the information about the site, and everyone can then use that information when referring to that site. Likewise, every customer can populate their own information.

The above-described scenario is not always possible. Thus, in one embodiment, organizations can register trading partners and objects with the registry needed to describe equipment, areas, locations, and other objects needed for contract monitoring. For example, rental companies can provide their own make, model, and classification information. Rental companies and rental customers can also provide their own location information. Rental companies can also provide information about each of their participating customers. As a result, multiple organizations will have their own version of information that refers to the same equipment make/models, locations, and customers. As discussed above, the various versions can be linked in the registry. In a further embodiment, one organization can subscribe to another organization's information about an object. An organization can be notified when it attempts to register an object that has been previously registered and given the option to subscribe to one of the existing registrations instead.

In one embodiment, for each object, or set of data, e.g., equipment, location, and trading partner, companies can either (a) “subscribe” to and use another organization's data (if it exists and that organization has made it subscribable to other organizations) or (b) create and maintain their own version of that data (which is necessary if the data has not been previously registered by another organization). In a further embodiment, if an organization is maintaining its own version of the data and later wants to subscribe to another organization's version (e.g., the industry steward's data), that can be done through a “link” as described above. Such a link is maintained until either organization breaks the link.

Various types and hierarchies of contracts can be used. For example, individual rental contracts (or orders) can be used for a single stand-alone rental. In this case, the individual rental contract contains all of the terms relevant to the contract. Such contracts are often informal and may not be written. Such contracts can also be part of a master rental contract that governs an ongoing relationship between organizations. Such contracts identify the terms and conditions that apply to all (or groups of) individual rental contracts. A master rental contract specifies how or when individual rental contracts become legally binding. For example, a master rental contract can specify that an individual rental contract becomes legally binding upon a delivery or fulfillment event notification from a particular contract monitoring system. A contract monitoring system can offer a menu of standardized master rental contracts for the use of various organizations. This standardization allows performance to be meaningfully compared across organizations.

In a particular embodiment of the subject invention, a rental contract is described. The contract describes one or more equipment units to be rented. The equipment can be described by, for example, its serial number or other unique identification number, a specific model or sub-model can be used (e.g., Genie AWP40S) and/or functional description can be used (e.g., Aerial Work Platform >=40 feet). Equipment can also be designated by equipment class (e.g., light bulldozer). Additional requirements can also be included in the contract description, such as to include a safety harness, attachments, consumables, etc.

In one embodiment, the contract describes a location for performance of an obligation under the contract. Such a location can be associated with a corresponding performance event. For example, a delivery event may be specified to occur at a particular location. A location can be registered separate from the contract or order, so that multiple equipment units can be set for delivery to the same location and performance can be tracked for each specific location. The description of a rental contract can include a pick-up and delivery location for the rented equipment. A window of time can be designated during which the equipment can be delivered or picked-up.

In one embodiment, performance events are described representing performance of a contract obligation. Failure events can be described representing a failure of such performance, for example, failure to pay an invoice when due, failure to deliver ordered equipment, breakdown of delivered equipment, etc. A failure event can be automatically generated when it is determined that an organization is not in compliance with a SOR, for example, during an update equipment status process. Failure events can be paired with resolution events, which describe how a failure was resolved.

The description of a performance event can include, a unique event identifier for the event, an originating order identifier, a location identifier of a pertinent location, an exception to the location information (e.g., left outside gate due to locked gate), a date or time the event occurred, a date or time the event was discovered, a date or time the event was reported, a date or time automatically generated by a rental management system, a date or time automatically generated by a contract monitoring system, a communication method used to communicate the event (e.g., telephone, face-to-face, e-mail, web portal, text message, etc.), indicia for a user or party who communicated the event, indicia for a user who was notified of the event, indicia for a user who verified the event, and/or indicia for a user who disputed the event. An event type can be included in an event description, such as delivery, pick-up, delivery failure—late, delivery failure—wrong/incomplete equipment, equipment failure, among other possible event types. Equipment failures can be described as complete failures, partial failures, or as having no or negligible customer impact. A description of the failure is also included (e.g., ruptured hydraulic line).

Event information can be presented or transmitted by a contract monitoring system or method as an event message. Such information can be communicated using various communications methods. In one embodiment, an event notification is sent to a rental management system or a component of the contract monitoring system itself (e.g., an internal message).

Types of event notifications can include, but are not limited to:
Order Event notifications—used to confirm an order between a supplier and a customer. For example, customer contractually accepts an order unless some action is taken (e.g., a rejection message is received). In another embodiment, the customer contractually rejects the order unless some action is taken (e.g., an acceptance message is received). In another embodiment, the order is separately rejected or accepted and the notification is informational.
Transportation Event notifications—used to describe an event whereby a unit of equipment was transported to, or transported from, a location in support of fulfilling an order.
Performance Failure Event notifications—used for performance failures.
Failure Resolution notifications—used for the resolution of performance failures.
Dispute Event notifications—provide notice of a performance dispute. In one embodiment, a dispute notification is presented to all parties to the contract. In another embodiment, the dispute notification is not presented to the party that originated the dispute.
Dispute Resolution Event notifications—provide notice of a resolved dispute. A dispute resolution notification is presented to all parties to the contract.

Different types of event notifications can be sent to different contacts within an organization. In one embodiment, an event status is associated with an event. The event status indicates whether an event has been disputed or verified or verified by silence. In a further embodiment, when a dispute event has been resolved the event status stores information about the dispute resolution.

Performance events can be chronologically grouped into performance periods and/or grouped by area. Multiple performance periods can be defined for various purposes and such periods can overlap. Performance periods can correspond to contracts, orders, or line-items. For example, where contracting parties have an ongoing relationship, defined by a master agreement, performance may be measured or compensated on a periodic basis regardless of the start or end of a particular individual contract. For example, settlement statements can be generated for payment on a monthly basis (a settlement cycle), while performance measures can be evaluated on a semi-annual basis. SLAs set performance thresholds that are evaluated on a periodic basis. Such thresholds can affect an adjustment to a settlement statement generated over a different performance period. For example, a SLA can require that a certain performance measurement, such as uptime (a measure of the percentage of time during which equipment was operational to the total time for which the equipment was contracted) be maintained over the course of a fiscal year. But if the threshold is breached, the SLA can require financial compensation (as a form of a non-performance penalty) calculated as a percent of every settlement statement generated during that fiscal year.

Preferences can be set to pick among standard performance periods, such as monthly, every four weeks, or semi-annually. Multiple line items corresponding to individual equipment rentals can be evaluated within the same performance period. Each line item has its own performance period coinciding with its rental start, e.g., a performance period is every four weeks beginning with the rental start.

An organization can have different contacts for using or supporting various functions. Such contacts can represent different contact addresses for the organization, for example different phone numbers, extensions, voicemail boxes, email addresses, P.O. boxes, or other addresses. Such contacts can also represent different persons within the organization. Such contacts are assigned to use or support various functions of a contract monitoring system, such as the contract monitoring system. The following table contains example contacts for such a system.

| Title | Point of Contact For | Example Actions |
|---|---|---|
| Inventory Contact | Equipment order, any changes to | Initialize, validate, or dispute an |
| | the order including its cancelation | order event or an equipment |
| | or termination, and any equipment | mismatch event. |
| | mismatch events. | |
| Transportation | Delivery and pick-up of equipment | Initialize, validate, or dispute a |
| Contact | and confirmation of same. | transportation event. |
| Service Contact | System failures and their resolution. | Initialize, validate, or dispute a |
| | | failure or resolution event. |
| Financial | Settlement statements and financial | Initialize, validate, or dispute a |
| Settlement Contact | settlement transactions. | financial settlement transaction. |
| Performance | Performance notifications. (See | Receive selected event notifications. |
| Contact | below) | |
| Registration | Initial registration and any changes. | Register or modify the organization |
| Contact | | registration. |
| Dispute Resolution | Disputes. (See below) | Initialize or respond to a dispute of |
| Contact | | an event. |
| Administrative | Administrative activities, | Manage contacts, set preferences, |
| Contact | preferences, and options (e.g., | manage options, and receive |
| | Billing and SLAs). | subscribable object notifications. |
| Terms & | Terms and conditions. | Establish and maintain contract |
| Condition Contact | | terms and conditions. |
| Area Contact | Areas. | Access status and performance data |
| | | pertaining to areas. |

A hierarchy of contacts can be defined, such that if a specific contact is not defined for a particular function that function is used or supported by a more general contact in the hierarchy. For example, if a dispute resolution contact is not defined, the functions used or supported by the dispute resolution contact default to the underlying function, e.g., the transportation contact for transportation disputes.

### Systems for Contract Monitoring

In one embodiment, a system receives contract terms related to the contract and event messages, which describe performance of the contract terms. The contract monitoring system acts as a neutral moderator, which receives, stores, and presents performance information from/to one or more parties to the contract. The performance information can be analyzed with regard to the contract terms. The performance analysis can be used to generate one or more performance measures for evaluating a party to the contract. The performance analysis can cover performance events during a performance period and/or can cover performance events associated with an area, model, class of equipment, equipment unit, or other organizational boundary. The performance analysis can also be used to generate a settlement statement (or invoice) for the contract. The contract monitoring system can be used to store, generate, and/or present resource, settlement, performance, and/or event information related to a plurality of organizations.

The contract monitoring system can be provided by a single computer or can be distributed amongst a plurality of computers on a network. The contract monitoring system can also be distributed among one or more program modules, such as, for example, an organization management module, a resource management module, an area management module, a requirement management module, an event management module, a performance analysis module, and/or a registry. Generally, program modules include routines, programs, objects, components, data structures, etc., that perform particular tasks or implement particular abstract data types.

An organization management module can register one or more organizations with the contract monitoring system, a resource management module registers one or more resources with the contract monitoring system, and an area management module registers one or more areas with the contract monitoring system. A requirement management module can receive a contract registration and break down the contract into individual line items, which can be compared to performance events. Thus, the requirement management module can produce one or more requirements corresponding to obligations under the contract.

The contract can relate to one or more organizations, resources, and/or areas registered with the contract monitoring system. In one embodiment, an event management module receives an event message describing performance of an obligation under the contract. A performance analysis module compares the event description to an individual line item to analyze compliance with the contract. The performance analysis module can produce a credential corresponding to the event message and compare the credential to a requirement produced by a requirement management module.

### Computer Implementation

The invention may be practiced with a variety of computer-system configurations, including multiprocessor systems, microprocessor-based or programmable-consumer electronics, minicomputers, mainframe computers, and the like. Embodiments of the present invention may be embodied as, among other things: a method, system, or computer-program product. Accordingly, the embodiments may take the form of a hardware embodiment, a software embodiment, or an embodiment combining software and hardware. In one embodiment, the present invention takes the form of a computer-program product that includes computer-useable instructions embodied on one or more computer-readable media.

Computer-readable media include both volatile and nonvolatile media, removable and nonremovable media, and contemplate media readable by a database management system, a switch, and various other network devices. By way of example, computer-readable media include media implemented in any method or technology for storing information. Examples of stored information include computer-useable instructions, data structures, program modules, and other data representations. Media examples include, but are not limited to, information-delivery media, RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These technologies can store data momentarily, temporarily, or permanently.

The invention may be practiced in distributed-computing environments where tasks are performed by remote-processing devices that are linked through a communications network. In a distributed-computing environment, program modules may be located in both local and remote computer-storage media including memory storage devices. The computer-useable instructions form an interface to allow a computer to react according to a source of input. The instructions cooperate with other code segments or modules to initiate a variety of tasks in response to data received in conjunction with the source of the received data. Communication between network elements may be wireless or wired.

Embodiments of the subject invention are further described below with reference to the attached Figures.

### Example 1

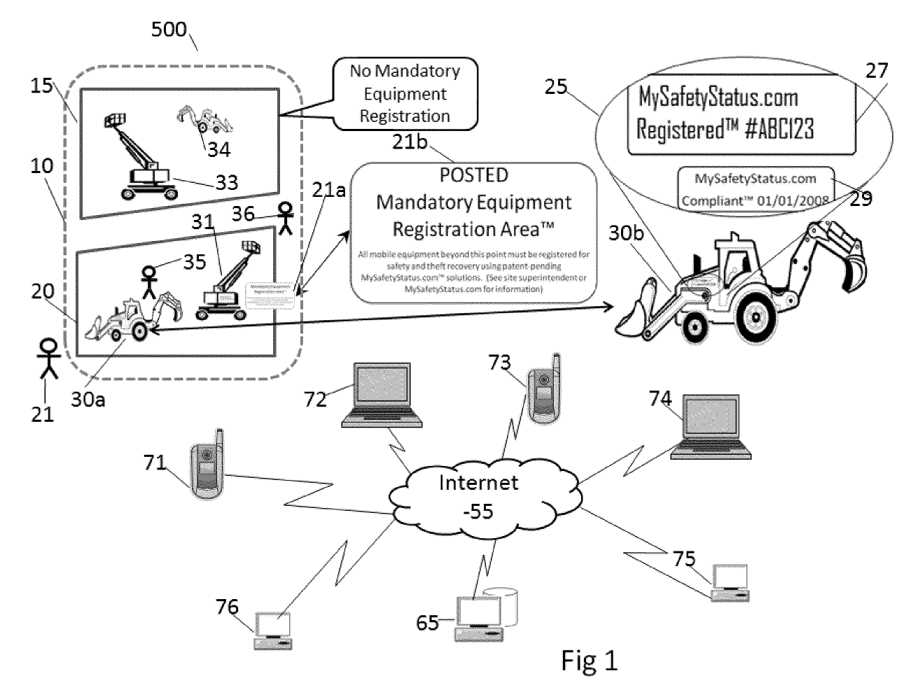

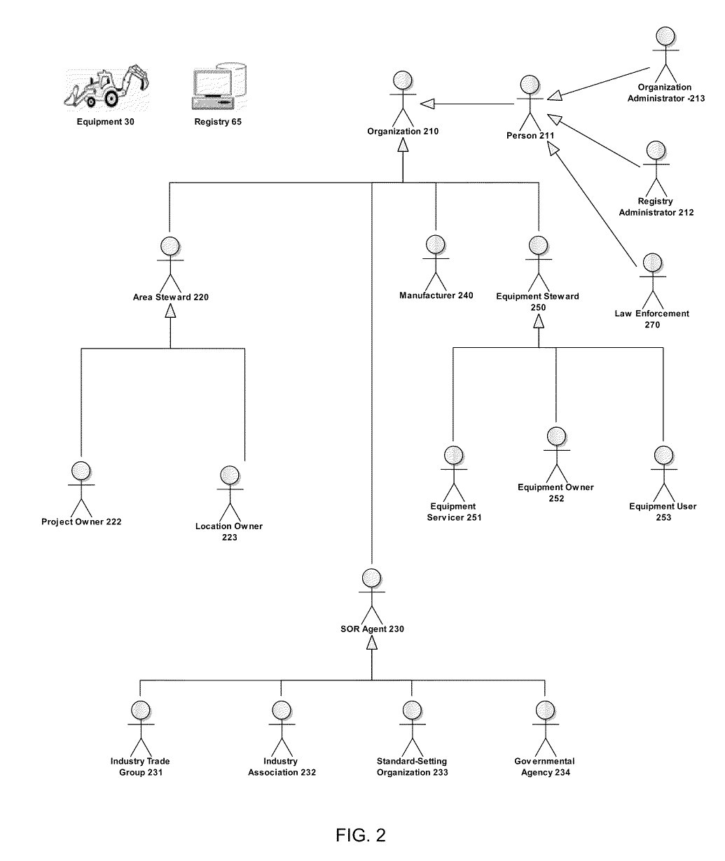

FIG. 1 provides a high-level context diagram of an equipment monitoring system 500. The system includes an area 20 and an area 15 located within a geographic area 10. While the areas and geographic areas are not themselves part of the system, data representations of the areas can be included. Area 20 requires registration of equipment entering the area, while area 15 does not. The system can include additional areas and geographical areas not shown.

The system also includes data representations of a plurality of equipment units of which four of the equipment units are depicted as examples: a first equipment unit 30a, a second equipment unit 31 within the area 20, a third equipment unit 33, and a fourth equipment unit 34 within the area 15.

First equipment unit 30a is also represented as an enlargement 30b that shows an enlarged inlay 25. The inlay 25 depicts a registration decal 27 on the first equipment unit 30a. In one embodiment, the registration decal 27 serves as proof of registration of the equipment unit 30a with the system 500. In a further embodiment, as shown in inlay 25, the registration decal 27 presents an equipment identifier that identifies the first equipment unit 30a within the system 500. In a further embodiment, the equipment identifier uniquely identifies the first equipment unit 30a within the system 500. In one embodiment, the equipment identifier is a string of numbers or other characters.

In a further embodiment, as shown in inlay 25, a safety status decal 29 is also attached to the equipment unit 30a. The safety status decal 29 can present information regarding the compliance of the equipment unit 30a with one or more SORs. The safety status decal 29 can also include an expiration date indicating whether the status information is up-to-date. The decal can include a citation where additional information can be found about equipment unit 30a. In one embodiment, an equipment identifier, such as the identifier presented on the registration decal 27, can be used to lookup information about the equipment unit. In another embodiment, the same or an additional equipment identifier is presented on the safety status decal 29. The registration decals and/or safety status decals are attached to all equipment within area 20. If another equipment unit enters or seeks entry into the area 20, the equipment unit is registered in the system 500 and corresponding registration and/or safety decal is attached to the equipment unit. In one embodiment, equipment outside area 20, such as equipment in area 15, can also be registered with the system 500 and present one or more decals.

Equipment decals and vinyl lettering are commercially available products, such as from PRODECAL™. In one embodiment, the wording used on the registration decals and the safety status decals is protected from illegal usage by copyrights, trademarks, servicemarks, certification marks, or other protections. The information can be presented audibly, visually, via radio frequency transmission, or via other communication technologies. In one embodiment, the information is encoded and can be written and read by an appropriately programmed device. For example, the information could be encoded as a bar code, an ASCII character string, and/or a modulated waveform.

Also depicted in FIG. 1 are a plurality of organizations shown as stick figures. Shown in this embodiment are an area steward 21, a first equipment steward 35, and a second equipment steward 36. Also shown in FIG. 1, is an equipment registration notice 21a. An enlargement of the notice 21b is also provided. The notice indicates that equipment should be registered with the system 500 and provides a citation for additional information about the system 500. Registration notices can be posted at, for example, the entrance to and/or throughout area 20. Notices can also be incorporated into agreements between parties related to a project. The notices shown here are presented via displayed text. The notices can also be presented audibly, visually, via radio frequency transmission, or via other communication technologies known in the art. In one embodiment, a registry 65, including a computer system and a database management system (or database), is connected to a network, such as the Internet 55. The network 55 interconnects the registry 65 with one or more communication devices. For example, the communication devices can include cellular telephones 71 and 73, laptop computers 72 and 74, and desktop computers 75 and 76.

In one embodiment, the registry 65 includes a multi-tier technology architecture including a presentation tier, a business tier, and a data tier. The presentation tier provides one or more user interfaces; the business tier manages business process rules and/or logic; and the data tier manages reading, writing, updating, and deleting stored data. The functions and/or tiers of the registry 65 may be housed in a single computer or distributed amongst various devices on a network, such as the network 55. The tiers and functions of the registry 65 can be implemented using various programming languages and development tools known in the art. For example, in one embodiment, the user interfaces are developed using Microsoft ASP.net forms with C# programming language code behind HTML, CSS, and JavaScript; the business process rules and/or logic are also developed with C#; and the data tier includes backend components and objects developed with C# mapped to a database leveraging Microsoft ADO.Net.

To illustrate the operation and some possible benefits of the subject invention, a scenario-driven illustrative example, using the system 500 of FIG. 1, follows. This scenario begins prior to registration of equipment units, areas, or organizations. The example illustrates registering the area steward 21, registering the area 20, establishing an agreement (not shown) to a set of terms and conditions for the area, and then elevating of the area 20 to that of a mandatory, registered work area.

In this example, area steward 21 desires to reduce the chance of equipment theft, improve safety, and reduce safety-related administration on an upcoming project in the area 20. The area steward 21 establishes the area 20 as a mandatory, registered work area. The area steward 21 and the area 20 are registered with a registry 65 before establishing the area 20 as a mandatory, registered work area.

The area steward 21 can become a registered organization by providing information representing its organization to the registry 65, thereby creating an organization registration. In a similar manner, the area steward 21 can provide information about the area 20 to the registry 65 to create an area registration. In one embodiment, the area steward 21 or other organization must be registered with the registry 65 before the organization may register areas, equipment, agreements, or other things with the registry 65.

Establishing a mandatory, registered work area can include establishing agreements, registering agreements, and/or posting notices, among other activities. In one embodiment, the area steward 21 enters into agreements with other persons requiring that equipment entering or used in the area 20 be registered. For example, the area steward can enter into such an agreement with the equipment steward 35, one or more contractors at the area 20, one or more owners of the area 20, an organization which maintains the registry 65, among other parties.

In a further embodiment, one or more of such agreements are registered with the registry 65 by providing information about the agreements to the registry 65. Various information about the agreements can be provided including the parties to the agreement, the area(s) associated with the agreement, the equipment steward(s) associated with the agreement. In one embodiment, the information provided includes a description of terms of the agreement. In a further embodiment, the information provided includes one or more customized SORs to be enforced as part of the agreement.

Establishing the mandatory, registered work area can also include posting notices. In one embodiment, the area steward 21 posts signs including notices such as notice 21b throughout the area 20. Where the area is related to a physical location, notices can be posted on signs at entrances to the physical location. Where the area is related to a contract, notices can be incorporated into the contract.

Next in this scenario, a construction contractor, represented in FIG. 1 by the equipment steward 35, desires to perform work within the area 20 using the equipment unit 30a. Because the area 20 is a mandatory, registered work area, the equipment steward 35 is required to register the equipment unit 30a before the equipment unit 30a enters the area 20. Where the area is defined by a physical boundary, a resource entering the area refers to the resource physically crossing the boundary that defines the area (i.e., passing through an entrance into the area). Where the area is not defined by a physical boundary, a resource entering the area refers to the resource being assigned to or otherwise associated with the area for use in the area. In an alternate embodiment, equipment is registered after entering an area but before being used in the area. In another embodiment, equipment is required to be registered within a specified length of time after entering the area (e.g., 2 business days). In this scenario, the equipment steward 35 becomes a second registered organization (a pre-requisite to registering its equipment) by registering with the registry 65.

In one embodiment, the equipment steward 35 registers the equipment unit 30a by providing information about the equipment unit 30a to the registry 65. The information can include equipment manufacturer, model, year, serial number, and type of equipment, among other information. In an alternate embodiment, the equipment unit 30a can be registered by the equipment steward 35 without the equipment steward 35 first registering his or her organization. In another embodiment, another person, such as area steward 35, may register the equipment unit 30a on behalf of equipment steward 35. Once the equipment steward 35 has registered with the registry 65, the equipment steward 21 may take over the maintenance of the registration for the equipment unit 30a.

As part of the registration process, organizations can identify one or more registered agreements that they are bound by. The registering organization consents to terms of such agreements as part of the registration process (e.g., by selecting an acceptance input). Organizations can also consent to affixing registration 27 and/or safety status 29 notices to equipment at the time of registration of the organization or the equipment. Organizations can also consent to provide and maintain equipment records as part of the registration process.

In certain embodiments, the registry 65 can be queried to obtain information about an equipment unit, an agreement, a registered area, another organization, or other information Some information in the registry 65 can be deemed “public information” and is provided to any person contacting the registry 65 regardless of their identity. Thus, some information can be made available to workers using equipment or other interested persons who may not otherwise have convenient access to such information. In a further embodiment, before providing information to a user the user is authenticated using an Authentication. Authorization and Accounting (“AAA”) protocol. Various AAA protocols are known in the art and can be used with the subject invention. In one embodiment, information provided by the registry 65 is limited in some manner so that confidential information of other organizations is not exposed. The amount or type of information provided by the registry 65 can be determined in part by the identity of the querying organization. In one embodiment, the amount or type of information provided by the registry 65 is determined in part by the services purchased by the querying organization. Based on the identity of the querying organization, additional input may be required before some information is provided by the registry 65. For example, an owner of an equipment unit may be provided with information about the unit based on any identifying information, including information that does not uniquely identify the equipment unit, while another querying person or organization may have to provide information which uniquely identifies the equipment unit before information about the unit is provided.

The registry 65 can be contacted through a communications device, via a network, or a telephone. In one embodiment, a touch tone interface is used to send some information to the registry 65. In another embodiment, customer service professionals are employed to enter information into the registry 65 and/or communicate query results to a caller.

Some embodiments of the subject invention can help detect stolen equipment or other resources, even if the owner of the equipment is unaware of its theft. For example, assume that the equipment steward 36 recently purchased the equipment unit 31 and registers it. However, the registry 65 has a prior registration for the same equipment manufacturer and serial number but for another organization. The registry 65 can detect this inconsistency and transmit a notification message to the other organization's registered equipment steward. Thus, the other organization, who had not even known the equipment unit 31 was stolen (and subsequently resold to equipment steward 36), becomes aware of the theft. The registry 65 can transmit the notification message to the equipment steward 36 and/or legal authorities in addition to or instead of the other organization registered to the equipment unit 31.

In a further embodiment, the registry 65 can be used by an organization to obtain information about an equipment unit during the purchase process. For example, a purchasing organization queries the registry 65 using the serial number and manufacturer of the equipment unit and receives information about the unit in response.

As the registry 65 penetrates the marketplace with increased proliferation of registered work areas (including, for example, in hot spots where stolen equipment tends to be purchased like Saudi Arabia, Mexico, and Dubai), the market for reselling stolen equipment would likely decrease thereby leading to a decrease in thefts. In one embodiment of the subject invention, a status indicator is attached to an equipment unit, such as equipment unit 30b, which presents status information. The status information can pertain to, for example, the equipment unit's compliance with a SOR. In one embodiment, contact information for the registry 65 is also provided along with the status information whereby an interested person can contact the registry 65 to obtain additional information about the equipment unit. The status indicator can comprise a communications device that can receive and/or transmit information to and from the registry 65. In one embodiment, the registry 65 sends updated status information regarding the equipment unit to the status indicator when a change in status is identified. Alternatively, the registry 65 can periodically transmits status information to the status indicator regardless of whether a change has been detected. In another embodiment, the status indicator also comprises a communications device capable of transmitting information to the registry 65 and the registry 65 for updated status information.

Convenient access can be provided to relevant and/or time-critical information via various mobile communication devices, such as cellular telephones 71 and 73 and laptop computers 72 and 74. In one embodiment, canned reports can be obtained from the registry 65 containing information relevant to those working in the field. An area steward can quickly and easily generate a report of the compliance status of all equipment used in the steward's area. In one embodiment, the registry 65 sends alert messages containing time-critical information. Alert messages can be sent via SMS or other message protocol, e-mail, instant message, chat, recorded voice message or voicemail, or radio transmission, among other communication techniques. For example, the area steward 21 might receive a SMS message on a cellular telephone registered with the registry 65 indicating that the equipment unit 30a is not in compliance with one or more SORs and may be unsafe to operate.

### Example 2

Aspects of the subject invention will next be described by reference to Unified Modeling Language (UML) diagrams. UML diagrams provide a means to model business requirements and/or design of a particular system. Three different types of UML diagrams (use case, activity, and class) are commonly used. Use case diagrams are commonly used in system analysis to identify, clarify, and organize system requirements. An activity diagram is a multi-purpose flow diagram that enables one to model business workflow and the behavior of system components. Class diagrams define the structure and relationships of objects in a business model.

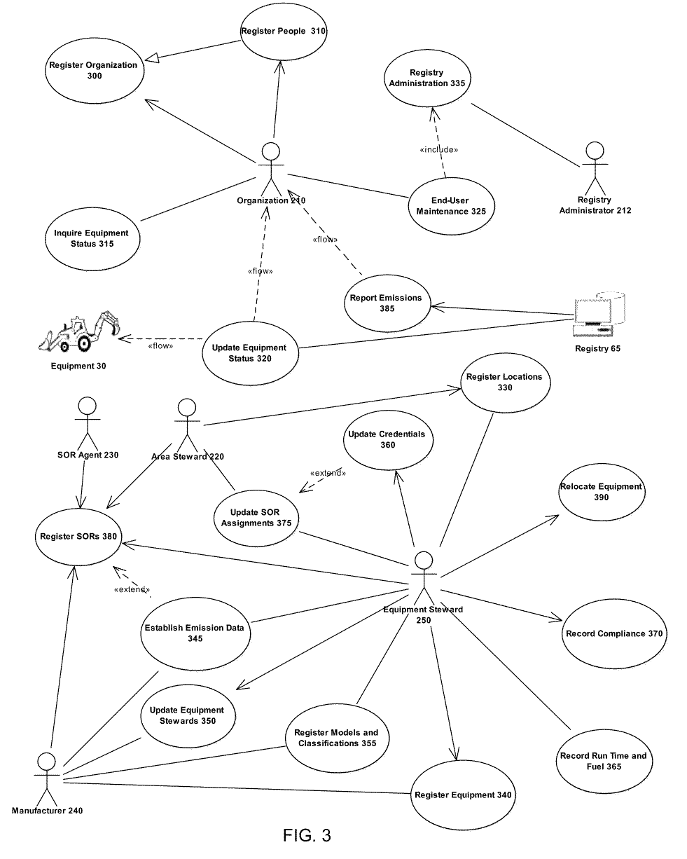

FIG. 2 illustrates an actor relationship use case diagram that shows relationships between various entities (e.g., organizations, organizational roles, and people) and objects (e.g., computer systems and equipment) that can interact according to the subject invention. A context-appropriate symbol is used to represent something that interacts with a particular system or sub-system. A stick figure of a person is used to represent a person or organization, a computer symbol represents a computer system (inclusive of a computer, display, input devices, storage devices, memory, and other typical components), and an equipment symbol represents an equipment unit.

The diagram of FIG. 2 shows that an organization 210 is a more generalized term for an area steward 220, an SOR agent 230, a manufacturer 240, and an equipment steward 250. Said differently, an area steward 220, an SOR agent 230, a manufacturer 240, and an equipment steward 250 each has additional specificity relative to the more general organization 210. These actors can also assume more specialized roles as shown in the figure.

A manufacturer 240 is an organization with a least some involvement in designing, building, assembling, distributing, and/or selling equipment. Multiple manufacturers 240 can be associated with an equipment unit 30. The manufacturer(s) 240 can populate data regarding equipment in the registry 65. For example, a manufacturer can populate data about its models including, for example, emissions data. The manufacturer can create service bulletins and/or SORs related to its equipment. In one embodiment, another organization can add and/or subscribe such information. An area steward 220 is an organization with legal and/or contractual rights and/or obligations related to an area. An area may be further characterized as a physical location (such as the boundaries of a construction site), a project not necessarily limited by physical boundaries (such as a multi-county tree trimming project for an electric company), or some other organizational boundary for a set of resources. In the embodiment shown in FIG. 2, a project owner 222 is a more specific form of the area steward 220 having rights and/or obligations related to a particular project. For example, the project owner 222 can be a party to a service agreement. Meanwhile, a location owner 223 also descends from the area steward 220, but has rights and/obligations related to a particular physical location. For example, the location owner 223 can be the owner of a construction site.

An SOR agent 230 refers to a third-party organization (i.e., other than an area steward, manufacturer, or equipment steward) that promulgate one or more SORs, such as an industry trade group 231, an industry association 232, a standard-setting organization 233, or a government agency 234.

An equipment steward 250 is an organization with legal and/or contractual rights and/or obligations related to equipment. The equipment steward 250 can also have a more specific role including an equipment servicer 251, an equipment owner 252, and an equipment user 253. The equipment servicer 251 is an organization that is authorized to service the equipment unit 30a, such as a mechanic service firm. An equipment owner 252 is an entity that has legal ownership rights to the equipment 30a. The equipment user 253 may be an owner 252 of the equipment 30a or anyone authorized by the equipment owner 252 to use the equipment 30a. For example, a rental company may own the equipment 30, and therefore be an equipment owner 252, and authorize their renter, who becomes an equipment user 253, to use the equipment 30. In another embodiment, the rental company leases the equipment 30 from the equipment owner 252 and then sublets the equipment 30 to the renter. In this case, both the rental company and the renter are equipment users.

In one embodiment, the manner in which an organization 210 is associated with an object in the registry 65 determines what level of access the organization 210 will have with respect to that object. For example, an equipment servicer 251 can have limited read access to information about a equipment unit 30 that allows the equipment servicer to schedule and perform needed maintenance. In addition the equipment servicer 251 can have limited write access to information about the equipment unit 30 that allows the equipment servicer 251 to record information relevant to these functions. By way of another example, a location owner 223 can be provided access to information about all equipment registered at that owner's location. Such access may be limited to only those fields relevant to the location owner's role. In another embodiment, the location owner 223 would have no access to information about equipment outside the location (unless the location owner 223 is otherwise related to the equipment).

Persons with different roles within an organization will often be interested in different information stored in the registry 211. In one embodiment, different interfaces to the registry 211 are provided that are limited or optimized for the functions performed by the different contacts. A variety of different contacts within an organization can be differentiated, including but not limited to, a purchasing contact, a transportation contact, a dispute resolution contact, a performance manager, an accounts payable contact, and an accounts receivable contact. FIG. 2 shows a few additional examples.

A registry administrator 212, is a specialization of person 211. The registry administrator 212 is responsible for the smooth running of the entire registry 65. Likewise, each organization 210 may have an organization administrator 213, who is responsible for the organization's data and shares responsibility with the registry administrator 212 for any interface between the organization's systems and the registry 65.

FIG. 2 also shows law enforcement 270, which is another specialization of the person 211. In one embodiment, law enforcement organizations may register with a registry (such as the registry 65). In one embodiment, law enforcement 270 are only permitted access to information about equipment after inconsistent ownership records have been found.

### Example 3

FIG. 3 illustrates a UML use case diagram, according to the subject invention. The diagram provides a graphics description of who or what initiates or triggers each major process. Use cases are represented by an oval containing its name. Lines connect use cases with actors or other use cases that initiate or trigger them.

In one embodiment, an organization 210 provides organization registry information through a register organization process 300. The organization registry information can include, for example, an organization's name, contact information such as address, telephone number(s), e-mail address(es), and unique identifiers such a tax identification numbers or a Dun and Bradstreet number. In one embodiment, the registry 65 also generates its own unique identification number for each organization 210 and establishes security to control access and modification rights to the organization information. In one embodiment, the organization 210 establishes, through the register organization 300 process, zero or more roles for itself as may be applicable. For example, the organization 210 can serve as an area steward 220, an equipment servicer 251, an equipment owner 252, an equipment user 253, among other possible roles.

Organization 210 may also use a register people process 310 to register people with different roles within its organization. In one embodiment, contact information gathered for an organization is also gathered for persons 211 within the organization. The contact information for people may be used by the registry 65 to control access and to direct particular information and communications to the appropriate persons.

An organization 210 can also have sub-organizations, such as subsidiaries or divisions that it may register with the registry 65 using the register organization process 300 and/or the register people process 310. In one embodiment, a parent organization automatically has read and modification rights to its sub-organizations.

In addition to an organization 210 self-registering, it may also register other organizations referred to as a Third-Party Organizations (TPOs) or Trading Partners. This may be useful, for example, when an organization such as an equipment owner 252 wants to associate Safety and Other Requirements (SORs) with a particular SOR agent 230, such as a particular government agency 234. This TPO feature may also be used, for example, by equipment rental companies that want to register their customers as equipment users 253 during the rental period. Rental companies can use the monitoring system 500 to promote their equipment safety record and provide their customers with access to safety related equipment status for their rented equipment. The rental customers also can register their organization and use the equipment monitoring system 500 for monitoring the safety of their equipment. In one embodiment, when an organization 210 registers a TPO, only the organization 210 that created the TPO registration has access to and is able to modify the TPO's information. The registering organization can later transfer control of the TPO registration to a registry administrator 212. The registry administrator 212 can then, if desired, modify a TPO registration such that it behaves as though the TPO self-registered, in which case the TPO itself becomes a registered organization 210 rather than a TPO. In another embodiment, the registering organization can transfer control of the TPO registration directly to the TPO, in which case the TPO also becomes a registered organization 210 rather than a TPO.

A register equipment process 340 can be used to create and manage equipment registry information regarding an equipment unit such as equipment unit 30. In one embodiment, this process accepts, stores, and manages information related to the equipment unit, such as its serial number(s), its owner-assigned number, its manufacturer and model number, its classifications (such as fuel type), and a unique equipment identifier as generated by the registry 65. This register equipment process 340 can be used by equipment stewards 250 and by manufacturers 240 to register their equipment. Equipment registration information is generally controlled by the organization 210 that registered the corresponding equipment 30 unless its control is transferred to the registry administrator 212.

In one embodiment of the subject invention, a register locations process 330 is used to identify locations to the registry 65 where equipment might be used or stored. Various information about the location can be obtained and stored during the registration process including but not limited to, a descriptive name, its location, and a unique registry-generated identifier. In one embodiment, locations can only be established by an organization 210 that has itself been registered using the register organization process 300. Once a location is registered by an area steward 220, the location information is available to any organization 210, or the area steward 220 can restrict access to the location information in the registry 65. In one embodiment, when a location is registered by other than an area steward 220, such as by an equipment owner 252, the information in the location registration is only accessible to that organization unless and until the location registration is transferred to, and accepted by, the registry administrator 212, or an area steward 220, in which case the information can become available to all registered organizations 210.

In one embodiment, an update equipment stewards process 350 is used to update the various equipment stewards associated with an equipment unit. For example, this process can be used when an equipment servicer 251, equipment owner 252, or equipment user 253 associated with the equipment unit is added, removed, or changed. In one specific embodiment, an equipment steward must first be registered via the register organization process 300 before it can be associated with the equipment unit via the update equipment stewards process 350. The update equipment stewards process 350 can be used by equipment owners 252 to specify to the registry 65 equipment servicers 251 and equipment users 253 associated with a registered equipment unit. The update equipment stewards process 350 can also be used by manufacturers 240 to reflect to whom their equipment was sold. Manufacturers 240 can later access the registry 65 to gather current ownership information on their equipment to support their efforts to disseminate equipment service bulletins and/or recall information.

Equipment location information is used in many aspects of the subject invention. For example, such information can be used to deter theft and aide in equipment recovery. Such information, can also be used to create location-wide SOR reports and alert notifications for all equipment at a given location. The relocate equipment process 390 allows an equipment steward 250, or other organization 210, to update the location of an equipment unit, such as the equipment unit 30, in the registry 65. In a further embodiment, functionality is included to reflect the start and end dates and times when the equipment unit enters and leaves a location. This can be accomplished by, for example, stationing RFID transceivers at the entrance and exit points of registered work areas and RFID tags on registered equipment. In a further embodiment, the process also allows an equipment steward 250 or other organization to provide a future planned location for an equipment unit, which can be used to validate SOR compliance before dispatching the equipment unit to the location. Thus, location-specific SORs can be addressed prior to the equipment unit arriving at the location. In another embodiment, the future planned location is used in logistics calculations so that equipment is allocated efficiently among locations.

In addition to equipment models defined by manufacturers, the subject invention allows organizations to create additional equipment classifications. Once these classifications have been created they can be made available and used globally (i.e., across all organizations 210) or they can be private and used by a particular organization 210. Examples of equipment classifications include power source, equipment category (e.g., cranes versus manlifts versus dirt equipment), size, and depreciation period (e.g., 5-year equipment). These classifications can allow grouping of equipment across manufacturers based upon similar specifications or functionality. These cross-manufacturer groupings can be beneficial, for example, when an organization has a SOR that its want to apply to all lift equipment taller than 10 feet.

The register SORs process 380 can be used by equipment stewards 250, area stewards 220, SOR agents 230, and manufacturers 240 to register SORs. An example of an SOR is a requirement, promulgated by a manufacturer 240, that particular equipment be inspected annually or an Occupational Safety Health Act (OSHA) (a government agency 234) requirement for all manlifts to be inspected quarterly. SORs can also be promulgated that are specific to particular areas, locations, projects, organizations, models, classifications, or other organizational boundaries. In one embodiment, the registry 65 captures a name, description, effective date, and expiration date for each SOR. It also captures information that identifies, either directly or indirectly, the equipment to which the SOR applies. Most SORs will apply indirectly, that is, they will apply to a model or to a classification of equipment and therefore indirectly apply to all equipment within that model or classification. Ideally, SORs are registered by the organization that promulgates the SOR; however, this is not always the case. For example, a manufacturer may have SORs for their equipment, but they might not be a registered organization within the registry 65. In this case, the registry 65 can allow registered companies to enroll the manufacturer as a TPO as described above.

Allocation steward 223 can establish SORs for equipment within their location to, for example, establish higher standards for safety. Similarly, an equipment owner or equipment user could establish SORs in pursuit of higher safety for their organization. Project stewards 222 equipment owners 252, equipment users 253, and other can all promulgate specialized SORs for all equipment assigned to a particular project. Various other organizations can promulgate SORs including, but not limited to, industry trade groups 231, industry associations 232, and standard setting organizations 233. In one embodiment, the subject invention standardizes SOR and equipment tracking such that an organization that sources its equipment from multiple rental companies has a standardized method for monitoring the safety of equipment provided by rental companies. For example, the registry 65 can produce a report for all equipment 30 associated with a particular organization 210.

In one embodiment, SORs are assigned to appropriate equipment through an update SOR assignments process 375. SORs can be directly assigned to particular instances of equipment 30. In a further embodiment, SORs are also indirectly assigned to equipment by classification or other organizational grouping. For example, SORs can be indirectly assigned to equipment via any combination of equipment manufacturer, model (along with manufacturer), classification, year of manufacturer, registered work area (assuming that it is a work-area-specific credential in support of a work-area-specific SOR, organization (assuming it is an organization-specific credential), and SOR(s).

In one embodiment, the establish emission data process 345 is an extension of the register SORs process 380. It functions in much the same way as the register SORs process, except it includes specific emissions data. The establish emissions data process 345 can be used to specify a rate and/or rating for an equipment unit that defines or estimates the amount of pollutants the equipment unit emits per unit of usage. The emissions data, when combined with run time, fuel consumption, or other usage information from the record run time and fuel process 365, can be used to calculate the equipment's emission of specified pollutants, such as particulates. The emissions data process 345 can be combined with location information in the registry 65 to track and report emissions data by location and across locations. The establish emission data process 345 can be used by both manufacturers 240 and equipment stewards 250 to establish emissions data for their equipment, while the record run-time and fuel 365 can be used by equipment users 253 to record run time or fuel use of their equipment.

Credential templates can be used to describe what is required to comply with various SORs. When a credential is discovered that matches the credential template associated with a requirement, the credential can be evaluated to determine compliance with the associated requirement. An equipment credential template can be used to describe a SOR related to a particular equipment unit or classification. For example, a credential template can describe a quarterly inspection requirement for aerial work platforms. The credential template describes various information needed to evaluate a corresponding credential, and thus satisfy the requirement. The corresponding credential provides the required information which is then evaluated to determine compliance with the corresponding requirement. The credential template can include an effective date or expiration date for the corresponding credential and once the credential is evaluated compliance is indicated for the particular time period. Compliance can be indicated or stored by one or more conformance or nonconformance records. Each conformance record indicates a date or time range during which the equipment is deemed in compliance with the requirement. Each non-conformance record indicates a date or time range during which the equipment is deemed not in compliance with the requirement.

The credential template can have one or more fields describing a credential. For example, the credential template can include a name of the corresponding credential, an equipment identification number for the equipment unit that must meet the corresponding requirement, the date of the credential, the name of a person who performed a required inspection, check boxes indicating specific items to be checked or replaced, among other information needed to evaluate compliance with the corresponding requirement. A credential template can be modeled after an existing form, such as an Aerial Work Platform. Quarterly Inspection Form.

A credential template can be used to describe requirements for multiple equipment units. In one embodiment, the credential template is shared across organizations, equipment manufacturers, projects, locations, and other organizational boundaries. A single credential can provide information needed for multiple credential templates and therefore can potentially satisfy multiple requirements. For example, an annual inspection record for a crane may satisfy a safety requirement described by one credential template and a maintenance requirement described by another credential template.

Credentials can be uploaded or entered into the registry 65 or otherwise identified to a monitoring system. An update credentials process 360 can capture relevant information about identified credentials, such as the credential's name, version, effective date, and expiration date. A record compliance process 370 can populate credential templates with information pertaining to a particular equipment unit or other resource. In one embodiment, an update equipment status process 320 compares SORs (as created by the register SORs process 380 and assigned to equipment through the update SOR assignments process 375) with credential templates and derives an equipment status. The equipment status can be provided to an interested organization 210 or to a related equipment unit 30. The equipment status can be presented on a status indicator attached to the equipment unit 30. In one embodiment, the equipment status is automatically presented on the status indicator without need for any additional human participation.

In one embodiment, a report emissions process 385 uses information gathered by the establish emission data process 345 and record run time and fuel process 365 to calculate estimated emissions on individual equipment and groups of equipment. The estimated emission information can then be provided to an organization 210.

An inquire equipment status process 315 can accept inquiries from an organization 210 and provides equipment status information in response including, but not limited to, ownership, location, and/or compliance to SORs.

In one embodiment of the subject invention, an end-user maintenance process 325 includes various processes that support each organization 210's use of the registry 65. For example, the end-user maintenance process can include provisions for an organization 210 to register persons associated with the organization and change their roles, permissions, preferences, and access privileges. These same processes are also available to a registry administrator 212 along with a registry administration process 335, which facilitates maintenance of the registry 65. For example, the registry administration process 335 can include utilities for maintaining a database used to implement the registry 65.

### Example 4

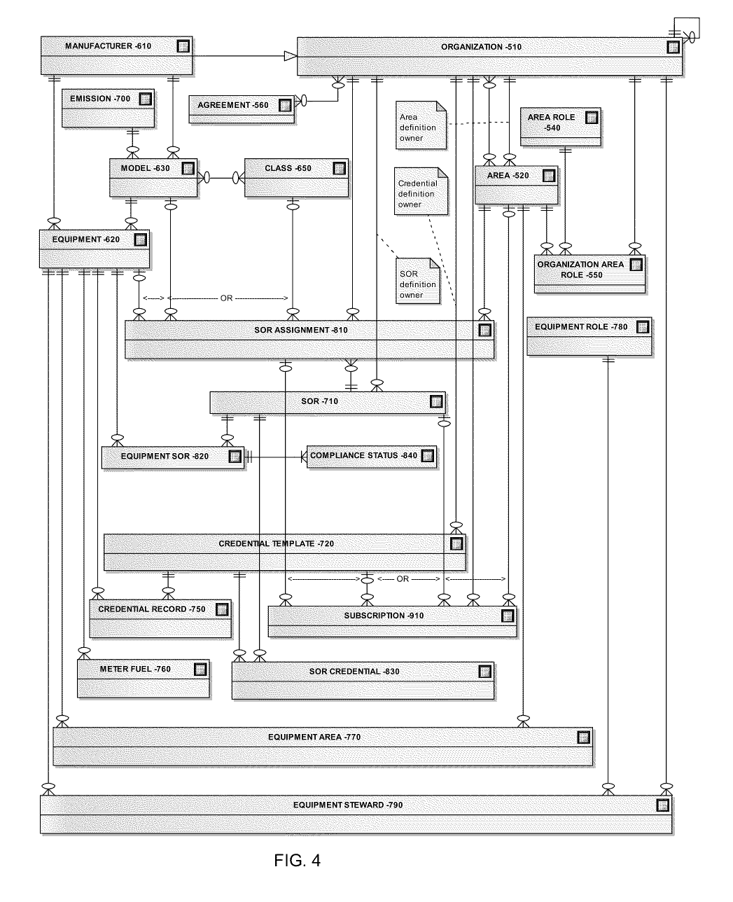

FIG. 4 illustrates a UML class diagram in accordance with the subject invention. Class diagrams such as this, also sometimes called domain or object models, identify objects, data about those objects, and relationships between those objects. In this figure, objects are represented by rectangles with descriptive names included therein. The connectors shown between objects conventionally provide information about the relationship between the connected objects. The connectors indicate how many instances of each object may or must exist (sometimes referred to as multiplicity) in relation to instances of the other object. Each object within a relationship has two parameters, a maximum occurrence and a minimum occurrence, defined and represented on the lines near each object. The maximum occurrence has a value of either one or many (i.e., more than one) and is represented as a perpendicular hash mark or a crow's feet symbol, respectively, located nearest to the object. Next to the maximum occurrence symbol is the minimum occurrence symbol represented as either a perpendicular hash mark, indicating a minimum of one occurrence or an oval representing that an instance of the object might not exist.

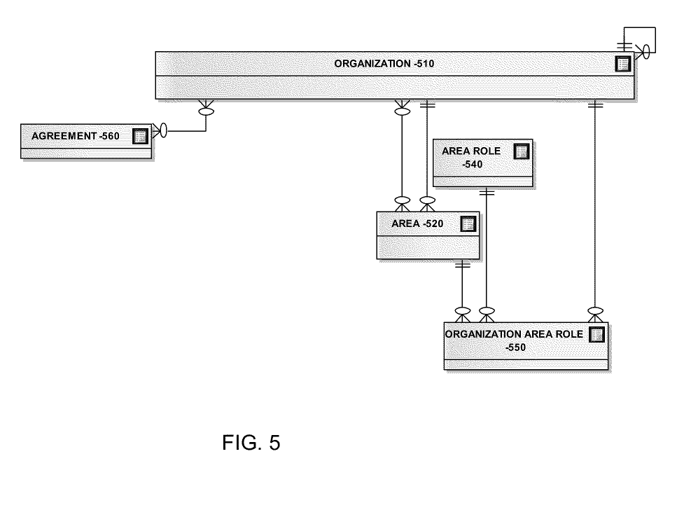

FIG. 5 illustrates a subset of the diagram of FIG. 4 showing an organization 510 and associated objects primarily related to the organization 510. FIG. 5 includes the organization 510, an area 520, an area role 540, an organization area role 550, and an agreement 560. Each instance of the organization 510 contains zero or more instances of the organization 510 in recognition of the fact that a legal entity may own one or more subsidiaries or have one or more divisions, departments, regions, agents, etc. Another embodiment, not shown, recognizes that a legal entity may be owned by multiple other entities, such as in a joint venture.

Organizations that use the subject invention may legally agree to specific Terms and Conditions (T&Cs) relevant to the operation of the invention. These terms and conditions can include, for example, agreement to post mandatory, registered work area notifications signs at each of its registered work areas or agreement to attach a specified registration insignia, status indicators, or tags on each registered piece of equipment. These T&Cs can be standardized such that they may apply to a plurality of organizations. As illustrated, each instance of the agreement 560 is associated with zero or more instances of the organization 510, and each instance of the organization 510 is associated with zero or more instances of the agreement 560.

The current embodiment, as illustrated, captures information relevant to registered work area in the area 520. As illustrated, each instance of the area 520 has exactly one owner and is therefore associated with exactly one instance of the organization 510. In another embodiment, the owner of the area 520 is not represented. In yet another embodiment, the area 520 is associated with multiple organizations 510 that each have an ownership or other relationship to the area 520. Each organization having a legal and/or contractual right and/or obligation related to an area, such as an area steward 220, can be represented by the organization 510 and area 520 respectively. Each instance of the organization 510 has zero or more instances of the area 520. Thus, each organization can own or otherwise relate to multiple areas.

People 211 can have various functions within their organization 210, such as previously disclosed for example in relation to FIGS. 2 and 3. Each person can access various registry 65 functionality, such as for example the functionality illustrated in FIG. 3. Such functionality can be grouped into one or more contact functions associated with a person, which define how a particular person communicates with the registry 65.

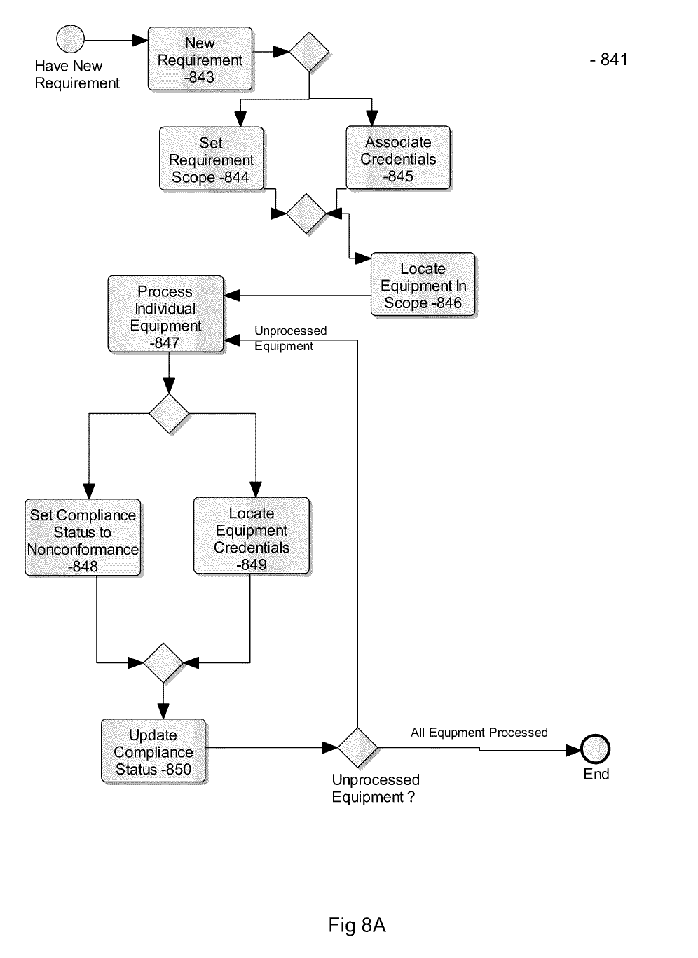

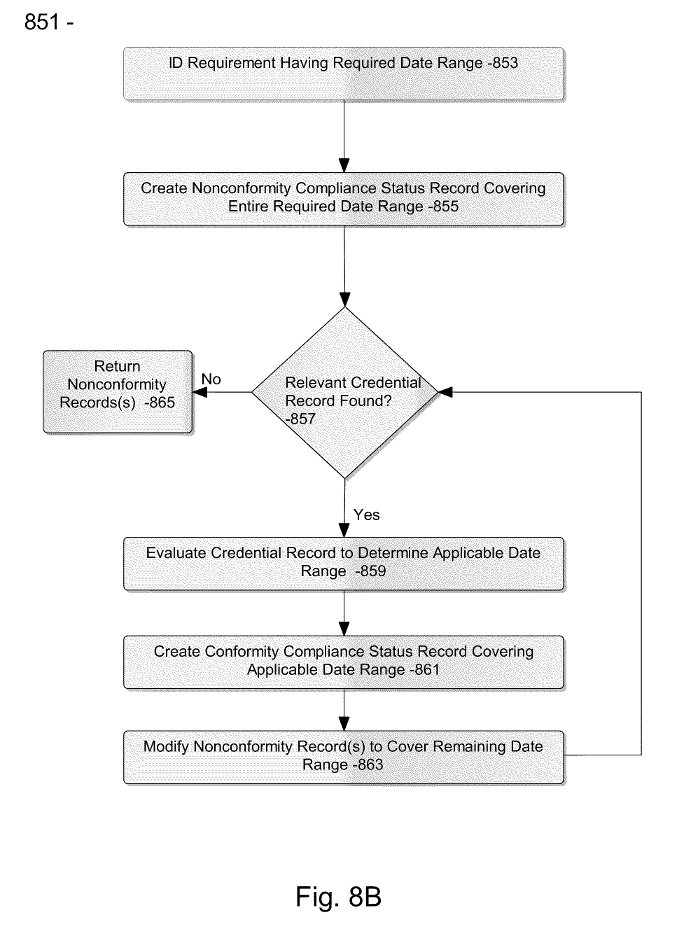

In addition, organizations as a whole can have various roles with respect to areas, equipment, SORs, and other objects. Illustrative examples of these roles have been previously discussed in relation to FIG. 2. For example, in the embodiment shown in FIG. 5, each organization 510 can be associated with an area 520 in two different ways. First, the organization 510 can be the definition owner of the area 520. This association is represented by the one-to-many relationship between organization 510 and area 520. Second, many organizations 510 can be associated with many areas 520 in terms of the different roles they each play with respect to the areas. In the embodiment shown, the role an organization 510 plays with respect to a particular area 520 is defined by an area role 540. The organization 510 is paired with the area role 540 via an organization area role 550. An organization 510 can also perform a particular role with respect to a particular equipment unit 620. In the embodiment shown in FIG. 4, the pairing of an equipment unit 620 with a role is defined by an equipment role 780. As depicted in FIG. 8, an organization 510 can relate to a SOR 710 directly or via a SOR assignment 810. An organization 510 can be related to a SOR 710 as the SOR's definition owner. In one embodiment, an organization 510 is related to a SOR 710 via a SOR assignment 810 because the SOR 710 applies to that organization 510.

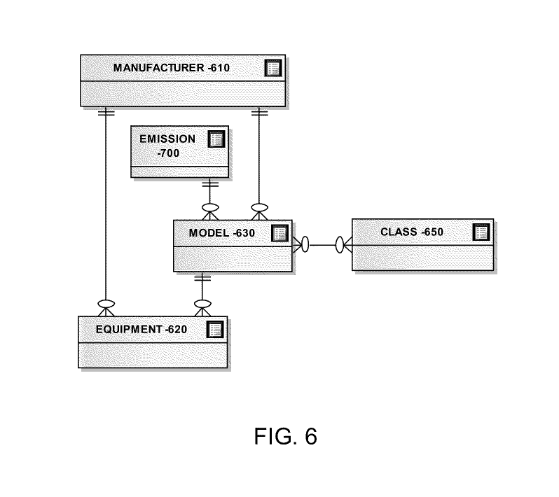

FIG. 6 is another subset of FIG. 4 and shows an equipment unit 620 and non-operating associations (i.e., associations not related to ongoing operation of the equipment unit) primarily related to the equipment unit In FIG. 6, each instance of the equipment unit 620 can be associated with a manufacturer 610, a model 630, and a plurality of classifications or classes 650. The class 650 is indirectly associated with the equipment unit 620 through the model 630. Thus, equipment models can be associated with one or more classes and any equipment unit of that model is indirectly associated with all classes associated with that model. In another embodiment, the equipment manufacture 610 is indirectly associated with the equipment unit 620 via the model 630. In an alternate embodiment, an equipment unit can be directly associated with one or more equipment classifications 620. In one embodiment (not shown), each model 630 can be associated with one or more sub-models, which are subsets of the model. In another embodiment, each class 650 can be associated with one or more sub-classes, which are subsets of the class. Thus, hierarchies of models and classes can be represented, stored, maintained, and used via the registry 65.

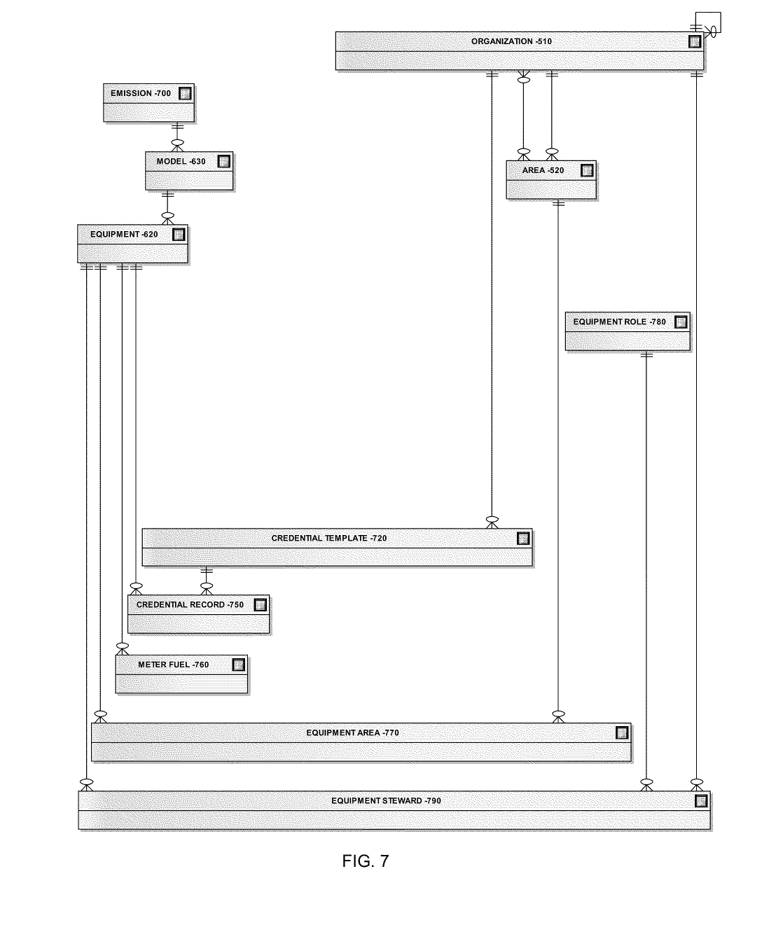

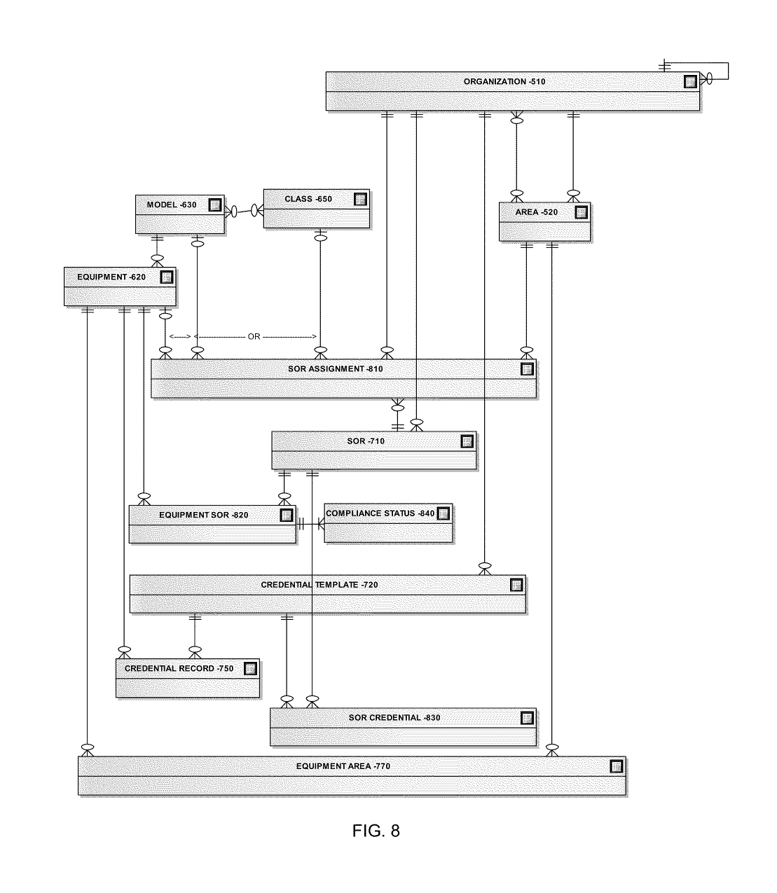

FIG. 7 is another subset of FIG. 4 and shows operating associations primarily related to the equipment unit 620. A manufacturer or other entity specifies emission specifications that identify the emissions produced during the operation of a vehicle. The emissions specifications can be specified for various sets of equipment or resources. For example, the specifications can be specified for an equipment model, an equipment classification, or for specific equipment units as identified by equipment serial numbers or other indicia, among other sets of equipment or resources. In the embodiment shown, an emission 700 captures instances of emission specifications and each instance of the emission 700 is associated with either zero or more instances of the model 630 or zero or more instances of the equipment unit 620, but not both. In an alternate embodiment, the emission 700 can be associated with both an equipment unit 620 and a model 630. Zero or more instances of the model 630 may exist without any associated instance of the emission 700. Zero or more instances of the equipment 620 may exist without any associated instance of the emission 700.

A template is a standardized form, card, or other template that, once completed with requisite information, results in a record, for example, that some event occurred, that some competency exists, or that some capability is present. The subject invention can capture information to represent credentials in a credential template 720. The credential template 720 can capture a name, description, a unique identifier, effective date and time, expiry date and time, and other relevant information regarding a credential as will be obvious to those of ordinary skill in the art. Each instance of the credential template 720 is associated with exactly one instance of an organization 510 and also applies to all associated sub-instances within that organization 510 instance.

In the embodiment shown, when an instance of the credential template 720 is completed for an instance of equipment 620 the result is represented by an instance of the credential record 750. Each instance of the credential record 750 has exactly one instance of an equipment unit 620 and one instance of a credential template 720. Each instance of the credential record 750 contains representative information from the completed credential template, such as the unique identifier of the instance of the equipment unit 620, the date that it was completed, the date the credential record 750 was created, and other information needed to evaluate the corresponding SOR.

In one embodiment, equipment run-time information and/or fuel consumption information are used in conjunction with equipment emission specifications to calculate equipment emissions. In the embodiment shown, meter fuel 760 captures instances of fuel consumption and/or operating hours for instances of the equipment 620. For each instance of meter fuel 760, there exists exactly one instance of equipment 620.

Equipment and/or resource locations can be tracked and can be combined with other information to produce useful data, such as emissions tracking, theft deterrence, SOR compliance, and other data by location. In one embodiment, an equipment unit 30 has a location attribute, that can be updated as the equipment moves from one physical location to another. In the embodiment shown in FIG. 7, an equipment unit 620 can be associated with an area 520 via an equipment area 770. As discussed above, areas can be used to represent different types of organizational boundaries. The boundaries and resulting sets defined by the areas can overlap; and different organizations can have shared or different definitions of the same or overlapping area. Areas can be used to represent equipment and/or resources located at a particular physical location. When an equipment unit 620 moves, its associations with various areas 520 are updated to reflect the changed location. Different area definitions can be used to support different functionality. For example, an equipment unit 620 can be in one area 520 for the purpose of emissions tracking, and in another area 520 for the purpose of theft deterrence functions, and in a third area 520 for the purpose of SOR compliance tracking. The instances of equipment area 770 each include a start date and time and an end date and time, among other possible information. These start and end times can contain future information and can facilitate logistical analysis related to how resources and/or equipment can be most efficiently deployed.

As previously disclosed, there is a plurality of equipment steward roles. These roles can be used to establish access to, and control of, the functionality of the registry 65, and/or a monitoring system, such as the monitoring system 500. Such roles are indicated via an equipment role 780 associated with an equipment steward 790. In the embodiment shown, an organization 510 has zero more equipment stewards 790, and each equipment steward 790 is associated with exactly one equipment role 780. In an alternate embodiment, each equipment steward 790 could have multiple equipment roles 780, as people in an organization often wear multiple hats. The roles can be specified by the registry administrator and/or the organization administrator.

FIG. 8 is another subset of FIG. 4 and shows a SOR 710 that represents Safety and Other Requirements (SORs) and related objects. The SOR 710 captures a standardized set of information representing a SOR. For each instance, the SOR 710 can capture a formal name, a common name and/or a short name for the requirement, an identifier for the requirement, an identifier of the organization that promulgated it, an identifier of the organization that is responsible for the requirement within the registry 65, an effective date and time for the requirement, an expiry date and time for the requirement, and a date of entry of the requirement, among other information regarding the requirement.

Various methods can be used to associate a SOR with an equipment unit or resource to be evaluated according to the SOR. In the embodiment shown, a SOR 710 is associated with an equipment unit 620 through a SOR assignment 810. Each SOR 710 is associated with one or more SOR assignments 810 which directly or indirectly link the SOR 710 to zero or more equipment units 620. The SOR assignment 810 can be associated with the equipment unit 620 in three different ways. The SOR assignment 810 can be associated: (1) directly with the equipment unit 620; (2) with a model 630 associated with the equipment unit 620; or (3) with a classification or class 650. Where the SOR assignment 810 is associated with a model 630, the corresponding SOR 710 applies to all instances of equipment 620 associated with that model 630. Where the SOR assignment 810 is associated with a classification 650, the corresponding SOR 710 applies to all models 630 associated with the classification 650 and transitively to all instances of equipment 620 associated with that model 630. In a further embodiment, each SOR assignment 810 is also associated with an organization 510, which established the SOR assignment 810 and/or is responsible for maintaining the SOR assignment 810 (i.e. the definition owner of the SOR assignment 810). In an embodiment not shown, the SOR assignment 810 may be associated with multiple organizations 510 which established the SOR assignment 810 and/or are responsible for maintaining the SOR assignment 810. A SOR 710 can be associated with an organization 510 which acts as the SOR's definition owner. The definition owner of an object is responsible for maintaining the definition of the object within the registry 65. Each SOR 710 can be also associated with zero or more instances of an area 520 via a SOR assignment 810.

In the embodiment shown, an equipment SOR 820 is generated for each combination of an equipment unit 620 and a SOR 710 that exists as a result of the SOR assignments 810. Each such equipment SOR 820 identifies an equipment SOR effective period for which the SOR 710 is applicable to the equipment unit 620. One or more compliance status records 840 can be used to describe the compliance of an equipment unit 620 with a SOR 710. A single compliance status record 840 can be set to either conformance or nonconformance based on the existence and/or evaluation of one or more corresponding credential records 750. If a credential record 750 exists that satisfies the corresponding SOR 710 (based on the corresponding credential template 720) the compliance status record is set to conformance. Otherwise the compliance status record 840 is set to non-conformance. In an alternate embodiment, all time periods within the equipment SOR effective period have one or more compliance status records 840 set to conformance (where there are one or more valid, corresponding credential records 750) and one or more compliance status records 840 set to non-conformance where corresponding credential records 750 are lacking. One such embodiment is described below with reference to FIG. 8B.

FIG. 8A is a flowchart illustrating a method 841 for evaluating compliance with a requirement, such as a SOR 710. At a step 843, a new requirement is received. At a step 844, the scope of the new requirement is determined. The scope of the requirement can be defined with respect to one or more organizations, locations, areas, or other organizational boundaries. SOR assignments 810 can be used to define the scope of the requirement as described above. At a step 845, credentials capable of satisfying the new requirement are associated with the requirement. Credential templates 720 can be used to associate credentials with the new requirement. As shown, steps 844 and 845 can run concurrently. At a step 846, one or more equipment units are found that are within the scope of the requirement (as defined in step the 844). Although equipment is described in this example, the method 841 can be applied to other resources as well. At a step 847, an individual equipment unit is considered. The step 846 may continue to locate additional equipment as individual equipment units are considered via the steps 847-850. At step 848, a compliance status record is initialized to “nonconformance.” At a step 849, zero or more equipment credentials are found which relate to the new requirement. At a step 850, credentials found in the step 849 are evaluated and, if a valid credential is found, the compliance status record(s) are updated to indicate conformance as appropriate. Single or multiple compliance status records can be used to describe compliance with the new requirement. As shown, steps 848 and 849 can run concurrently. Further, the step 849 can continue to locate additional credentials as found credentials are considered via the step 850. Once step 850 is complete, the method 841 returns to step 847 to process additional equipment units. Multiple equipment units may be processed concurrently.

FIG. 8B is a flowchart illustrating another method 851 for evaluating compliance with a requirement, such as a SOR 710. According to the method 851, the SOR 710 is evaluated over a required date range using one or more compliance status records 840. At a step 853, a requirement is identified having a required date range. The required date range is a SOR effective period as described above. At a step 855, an initial compliance status record, such as a compliance status record 840, is created having a date range associated with it. A compliance status record can be set to conformity or nonconformity indicating that the corresponding requirement is or is not satisfied for the associated date range. In the embodiment shown, the compliance status record is initially set to nonconformity and the associated date range is set to equal the entire required date range of the requirement. At a step 857, a credential record, such as a credential record 750, is searched for that is relevant to the requirement. If no relevant credential record is found, the method proceeds to a step 865. If a relevant credential record is found, the method proceeds to a step 859 where the found credential is evaluated.

The credential record can have a credential date range associated with it. The credential date range identifies the time period for which the credential is valid. For example, a CPR certification can be a credential that expires one year after the certification. In the embodiment shown, the evaluation of the credential includes determining the portion of the credential date range that is applicable to the requirement. In one embodiment, this applicable date range is the intersection of the required date range and the credential date range.

In a further embodiment, not shown, additional evaluation of the credential record can take place. For example, the credential record can be evaluated to make sure that it fully satisfies the requirement. This process can include comparing the credential record with a credential template, such as a credential template 720, associated with the requirement. If the credential record is found to be unsatisfactory the credential record can be disregarded and the method can proceed back to step 857.

Returning to the embodiment shown, at a step 861, a new compliance status record is created covering the applicable date range and set to conformity. At a step 863, the initial compliance status record is modified to cover the remaining date range. The remaining date range is found by subtracting the applicable date range of the credential record from the required date range. Steps 861 and 863 can be implemented in various ways. For example, where the applicable date range equals the required date range, the initial compliance status record can be set to conformity, no new compliance status record need be created, and no further modification of the initial compliance status record's date range need be done. Thus, in this case, there is no remaining date range and steps 861 and 863 are combined. When the applicable date range is less than the required date range, the nonconformity compliance status record is modified in step 863 to cover the remaining portion of the required date range. When the remaining portion of the required date range is in the middle of the required date range, the required date range is split by the applicable date range and an additional nonconformity record is created to cover the other portion of the required date range. Therefore, the result of the step 863 can be a nonconformity record, adjacent to a conformity record, adjacent to another nonconformity record. In an alternative embodiment, instead of creating multiple compliance status records, multiple date ranges can be associated with each compliance status record.

At this point, the method 851 returns to the step 857 to find and process additional credential records relevant to the requirement in light of the now existent conformity and nonconformity records. If no additional relevant records are found, the method 851 proceeds to 865 where the existent nonconformity records are returned. Thus, the periods of nonconformity over the required date range are identified by the method 851. In an alternate embodiment, the existent conformity records are returned instead.

In one embodiment, the method of FIG. 8B can be used to evaluate the compliance of an equipment unit 620 with a SOR 710 over the SOR effective period of the corresponding equipment SOR 820. In another embodiment, the method of FIG. 8B can be used to evaluate compliance with other requirements including requirements that are not associated with equipment or resources.

The subject invention can allow common data to be efficiently shared across organizations for one or more purposes. One organization 510 can subscribe to data entered and/or maintained by another organization in the registry 65. This feature can save each organization from reinventing the wheel every time they need to describe a new area, equipment model, SOR, or other object to the registry 65. Such potentially shared object definitions can be referred to as subscribable objects. Various objects can be implemented as subscribable objects including, but not limited to: models and classes of equipment; area, location, jobsites, projects, and agreement definitions (e.g. two organizations can share data regarding and agreement between them); SORs, SOR assignments, and credential templates. A definition owner can be associated with the subscribable object and is responsible for maintaining information about the object in the registry 65. Multiple definition owners can be associated with and potentially change the definition of a subscribable object. Although multiple organizations may contribute to the development of a subscribable object, for practical purposes only one organization is designated as the definition owner for each object. For example, in the embodiment shown in FIG. 4, single definition owner organizations 510 are shown to be associated with an area 520, a credential template 720, and a SOR 710.

A notification function can be implemented capable of notifying a subscribed organization when the definition of a subscribed object changes. The subscribed organization can thus be given the option of continuing the subscription, terminating the subscription, and/or modifying the subscription. The subscribed organization can be notified and given the option of adding a subscription to a related object. For example, if an organization is subscribed to a certain equipment model 630, the organization can be automatically notified and given the option to subscribe to a related equipment model 630. Subscriptions to related subscribable objects can be linked so that an organization can be given the option of updating a related subscription when a subscribed object changes. For example, an organization that terminates their subscription to a SOR 710 may also want to terminate their subscription to a credential template 720 related to that SOR 710. In another example, when a SOR 710 changes a subscribed organization can be notified and asked to update the SOR assignments 810 related to the SOR 710.

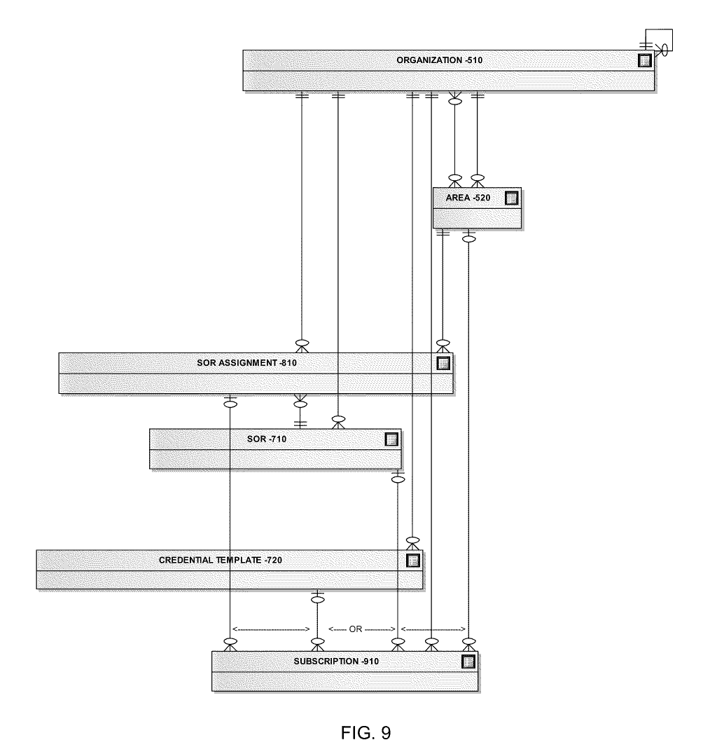

FIG. 9 is another subset of FIG. 4 and shows a subscription 910 and related objects in accordance with an embodiment of the subject invention. An organization 510 may subscribe to data maintained by another organization 510 by means of a subscription 910. For example, the organization 510 can subscribe to data regarding an area, equipment unit, SOR, among other data included in the registry 65. In this manner, the organization can use the data maintained by the other organization 510. In the embodiment shown, the organization 510 is linked to various data through instances of the subscription 910. Thus, the organization 510 is associated with zero or more instances of the subscription 910 which are in turn associated with zero or one instances of an area 520, a SOR assignment 810, a SOR 710, and/or a credential template 720. The objects shown are merely examples. Instances of subscription 910 can be used to link the organization 510 to other objects stored in the registry 65. In the embodiment shown in FIG. 9, each subscription 910 is associated with one organization 510 and one subscribable object. In an alternate embodiment, an organization 510 can subscribe to multiple (e.g. linked) objects via a single subscription 910. The subscription 910 can be used to link data maintained by trading partners.

### Example 5

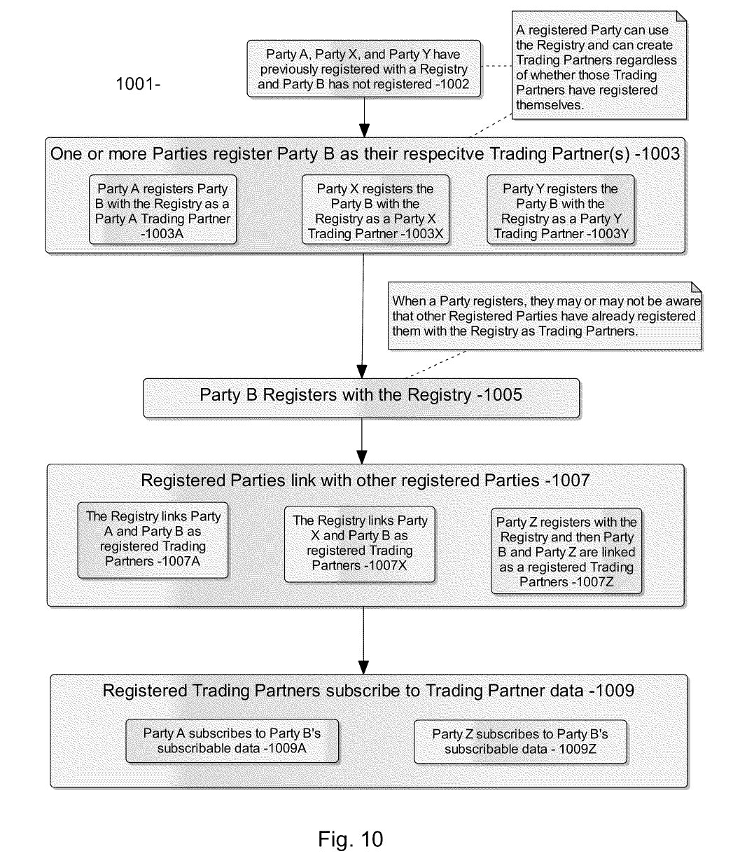

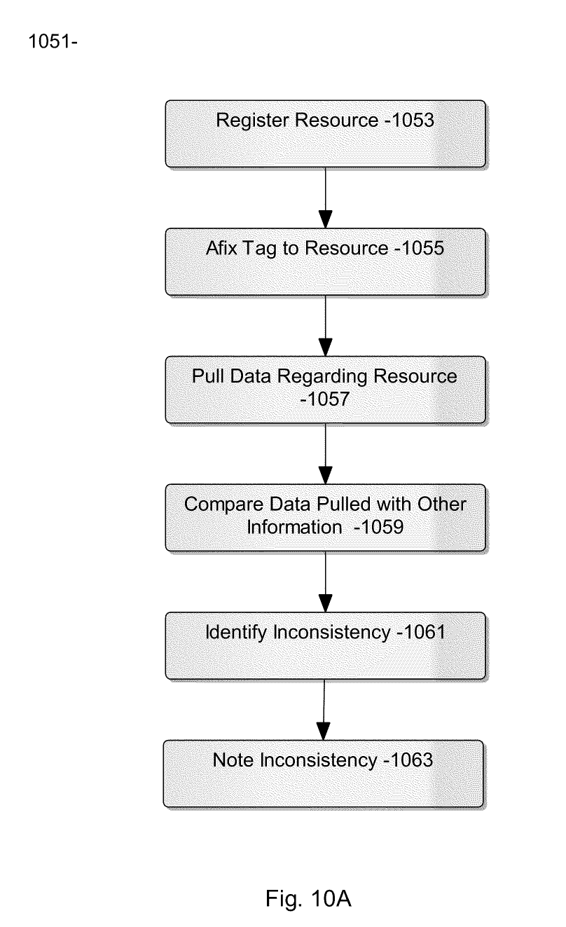

FIG. 10 is a flowchart illustrating a method 1001 of registering trading partners and sharing data between trading partners according to an embodiment of the subject invention. At a step 1002, a Party A, a Party X, and a Party Y have previously registered with a registry (such as the previously discussed registry 65) and a Party B has not registered. At a step 1003, one or more parties register party B as their respective Third Party Organization (TPO) or trading partner as described above. In this example, the Party A registers the Party B with the Registry as a Party A trading partner (at 1003A), the Party X registers the Party B with a Registry as a Party X trading partner (at 1003X), and the Party Y registers the Party B with a Registry as a Party Y trading partner (at 1003Y). While multiple parties each registered the Party B as their respective trading partner, there is nothing within the registry at this point that identifies Party B as the same organization or links the trading partner registrations. At step 1005, the Party B registers with the Registry. There is nothing within the registry at this point that definitively associates Party B with the aforementioned trading partner registrations of Party A, Party X, and/or Party Y. At a step 1007, registered parties link with other registered parties. In this example, the registry links Party A and Party B as registered trading partners (at 1007A). Likewise, the registry links the Party X and the Party B as registered trading partners (at 1007X). Also, a Party Z registers with the registry and then the Party B and the Party Z link as a registered trading partner (1007Z). The registration of Party B triggers the registry to search for and link related trading partner registrations. The registry notifies parties A, X, and Z of registration of Party B and asks if the registrations should be linked. If a party indicates that such linking is appropriate, the party is asked if they would like to subscribe to Party B's registration as further described below. At this point, the Party A, the Party X, and the Party Z are each linked with the same Party B (although each may not know about the other's link with the Party B). At this time, Party Y, who previously registered Party B as a Party Y Trading Partner (at 1003Y), has not been linked with the registered Party B. Party Y or any other party can perform their own search of the registry and identify registrations that should be linked. Finally, at 1009, registered trading partners selectively subscribe (such as with a subscription 910) to Party B's data for particular objects as described above. Specifically, Party A subscribes to Party B's subscribable data (at 1009A) and Party Z subscribes to Party B's subscribable data (at 1009Z).

A monitoring system, such as the monitoring system 500, can identify inconsistencies regarding information stored in a registry, such as the registry 65. The monitoring system identifies internal inconsistencies within the registry. The monitoring system can also identify inconsistencies between information stored in the registry 65 and other information sources. This function can be performed periodically, on command, or when new information is introduced to the registry 65. For example, when a new equipment unit is registered, the monitoring system can identify any inconsistencies between the registered data and the data already stored in the database. For example, the monitoring system can identify inconsistent ownership information for the new equipment unit as described above. The process of evaluating SORs is another example of this function. In that case, a nonconformity is an inconsistency identified by the monitoring system. The same process and objects can be used to identify and evaluate other types of inconsistencies. In a further embodiment the monitoring system presents information regarding the inconsistencies to one or more users via various presentation methods.

FIG. 10A is a flowchart illustrating a method 1051 of managing resources. At a step 1053, a resource is registered with a registry, such as the registry 65. As described above, various information regarding the resource can be received and stored at this time. At a step 1055, a tag is affixed to the resource including an identifier that uniquely identifies the resource to the registry. As discussed above, the tag can comprise various devices and technology including, but not limited to, numbered stickers, decals, radio frequency identifiers (RFIDs), identification cards, and engraved or stenciled lettering, among other possible devices. At a step 1057, the identifier is used to pull data regarding the resource from the registry. In one embodiment, the step 1057 occurs latter and is triggered by an outside event. The triggering event can be, for example, the movement of the resource, the availability of new or different information about the resource, the running of an update equipment status process 320 described above. At a step 1059, the data pulled is compared to other information about the resource. In one embodiment, the information about the resource comes from another source. For example, an existing registration of the resource can be compared to a new registration information for the same resource. Multiple trading partner registrations of the resource can be compared. Such comparison occurs when the registrations are linked as discussed above in relation to FIG. 10. At a step 1061, an inconsistency is identified between the data pulled and the other information about the resource. At a step 1063, the inconsistency is noted.

Ownership data from the registration of step 1053 can be compared to information provided by a person in possession of the resource. In one embodiment, such information is collected when the resource enters a registered work area. Where the ownership data is inconsistent with the information provided by the person in possession of the resource, legal authorities can be contacted and the inconsistent ownership information is communicated to the legal authorities.

The data pulled comprises maintenance data regarding the resource and the maintenance data can be compared to manufacturer recommendations regarding maintenance of the resource. When the inconsistency is found, the need for service can be noted in a service schedule for the resource, communicated to the resource owner, or otherwise noted as appropriate.

In one embodiment, information about the identified inconsistency is presented on or near the resource. The tag affixed to the resource can be capable of presenting a changeable message and the message is updated to note the identified inconsistency.

### Example 6

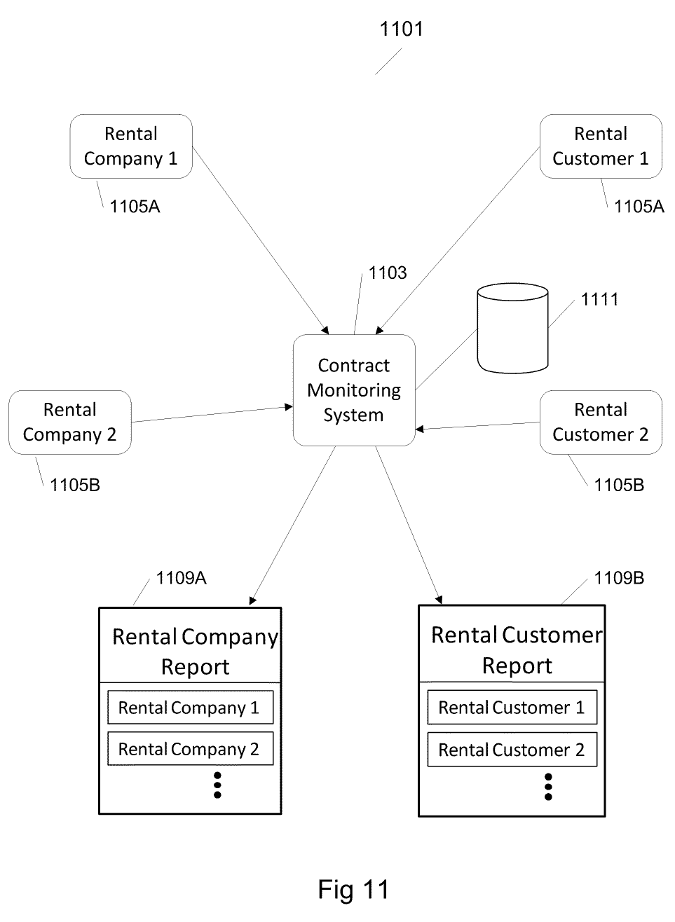

In one embodiment of the subject invention, a contract monitoring system or method collects data and reports information about multiple organizations. FIG. 11 shows one such embodiment. As illustrated by FIG. 11, a contract monitoring system 1103 can receive information from organizations, such as rental companies 1105A and B and rental customers 1107A and B, and produce reports, such as reports 1109A and B, presenting information across companies. In the embodiment shown, the contract monitoring system 1103 is connected to a registry 1111. The registry 1111 is implemented as the registry 65 discussed above. The registry 1111 can be incorporated into the contract monitoring system 1103 and/or distributed among one or more other network elements available via a network. This application and embodiment are illustrative examples. Other applications and embodiments can include more, fewer, or different inputs, outputs, and components. The inputs, outputs, and components shown here can also be differently arranged. In one embodiment, the reports 1109A and B can be used to compare various performance and other attributes of rental companies 1105A and B and rental customers 1107A and B.

The data collected and information reported can be related to company resources, SOR compliance, or other company performance. Such data can be summarized or broken down by area, model, class, time period, or other organizational grouping. Such reports can allow companies to compare the performance of multiple companies. In a particular embodiment, as further discussed below, such reports can allow a rental customer to compare the performance of multiple suppliers. Such reports can also allow a rental supplier to compare the performance of multiple rental customers. Various performance measures for a company can be tracked, calculated, and reported.

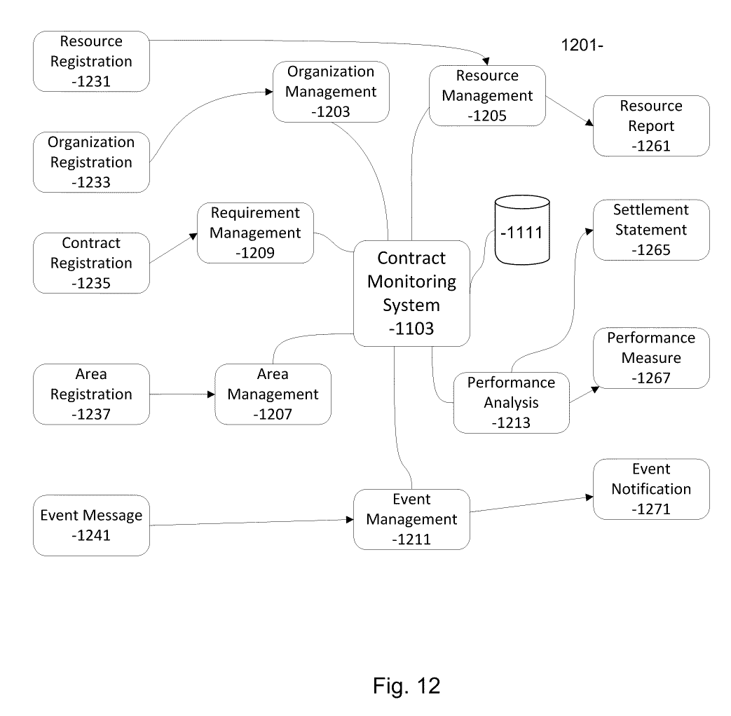

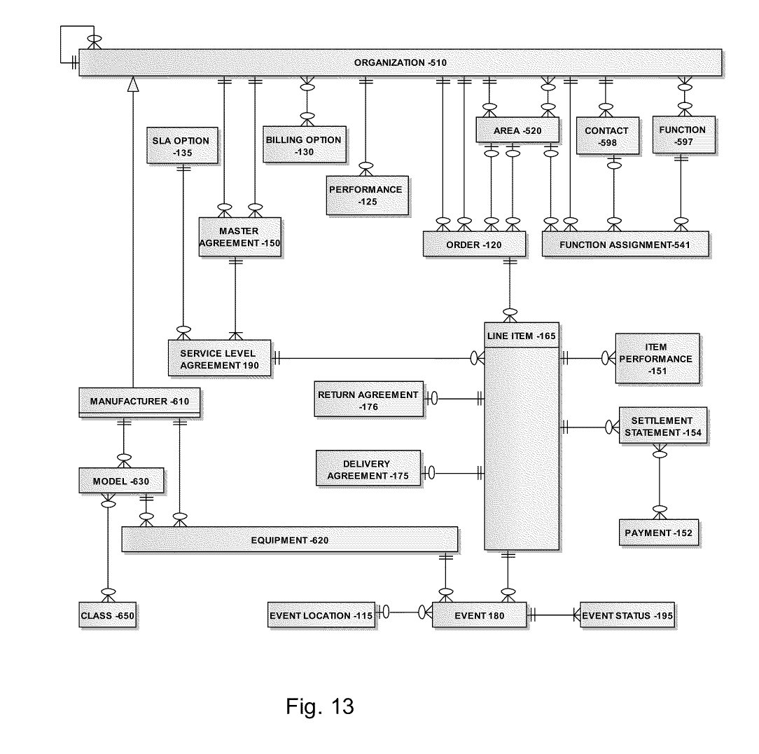

A contract monitoring system or method allows monitoring of contract performance across companies. FIG. 12 is a functional block diagram of one contract monitoring system according to the subject invention. FIG. 12 shows an example application 1201 of such a system 1103 including system inputs 1231-1241, system outputs 1261-1271, and program modules 1203-1213. This application and embodiment are illustrative examples. Other applications and embodiments can include more, fewer, or different inputs, outputs, and program modules. The inputs, outputs, and program modules shown here can also be differently arranged. As discussed above, the program modules 1203-1213 can be incorporated into the contract monitoring system 1103 and/or distributed among one or more other network elements available via a network. Various types of contracts can be monitored via the contract monitoring system, such as service contracts, purchase contracts, delivery contracts, among others. Hierarchies of contracts can be recognized and monitored. For example, master agreements can dictate terms for various sub-agreements between parties. A multiple and/or overlapping master agreements can affect the same parties. Contracts can also be broken down into orders covering a specific area or period of time. Orders can be further broken down into line items covering equipment to be delivered to a single location. Each line item covers a single equipment unit to be delivered.

Various Service Level Agreements (SLAs) can be monitored. SLAs are master agreements that set various performance thresholds for each party. If a threshold is breached an adjustment or other penalty can occur. Thresholds can be associated with various areas, models, classes, or other organizational groupings. Thresholds can be associated with particular time periods. For example, an SLA can set a threshold level for ontime delivery performance for a rental company. If a certain percentage of ontime delivery is not maintained, a price adjustment can be made for all contracts during a performance period. In another embodiment, the penalty can be nonmonetary, for example a loss of contract exclusivity or the loss of an option.

Various contract terms can be established and varied by various agreements including, but not limited to master agreements, SLAs, contracts, orders, and line items. In one embodiment, contract terms can be associated with an area, model, class, or other organizational grouping, or they can be applied globally.

Further embodiments of the subject invention are directed to a contract monitoring system or a method for contract monitoring for rental contracts. These contracts generally have two parties: a supplier (or lessor) of the rented item and a customer (or lessee) of the rented item. In one embodiment, the contact monitoring system and/or method for contract monitoring are adapted to monitor equipment rental contracts. The contract monitoring system or method can facilitate monitoring and/or reporting of contract performance across suppliers and/or customers.

FIG. 12 illustrates an embodiment of a contract monitoring system. In the embodiment shown, the contract monitoring system 1103 includes an organization management module 1203, a resource management module 1205, an area management module 1207, a requirement management module 1209, an event management module 1211, a performance analysis module 1213, and a registry 1111.

The contract monitoring system 1103 receives data regarding one or more data objects needed for contract monitoring. The system 1103 registers such objects with the registry 1111. For example, the organization management module 1203 can receive one or more organization registration messages 1233, which describe corresponding organizations, and register the corresponding organizations with the registry 1111, as discussed above in relation to the registry 65. The resource management module 1205 can receive one or more resource registration messages 1231, which describe corresponding resources, and register the corresponding resources with the registry 1111, as discussed above in relation to the registry 65. The area management module 1207 can receive one or more area registration messages 1237, which describe corresponding areas, and register the corresponding areas with the registry 1111, as discussed above in relation to the registry 65.

The requirement management module 1209 receives a contract registration message 1235, which describes a corresponding contract, and breaks down the contract into individual line items, which can be compared to performance events to gauge fulfillment of the contract. The corresponding contract and/or line items can then be registered with the registry 1111, as discussed above in relation to the registry 65. In another embodiment, the requirement management module 1209 produces one or more requirements corresponding to obligations under the corresponding contract. The requirements are registered via the register SORs process 380 and assigned as appropriate via the update SOR assignments process 375 discussed above. The corresponding contract relates to one or more organizations, resources, and/or areas registered with the contract monitoring system.

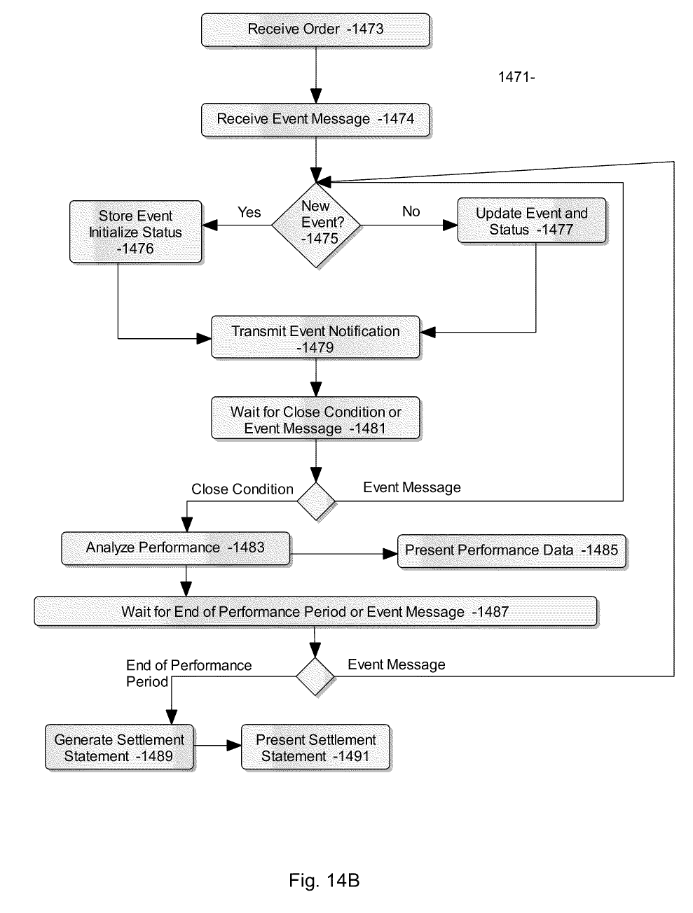

The event management module 1211 receives an event message 1241 describing the occurrence or nonoccurrence of an event related to performance of an obligation under the corresponding contract. The event management module 1211 verifies the event description with one or more parties to the contract. The event message is received from one contracting party and verified with one or more other parties to the contract. The event message is received from a rental management system. The event message is produced by the contract monitoring system 1103 itself. The event management module 1211 presents one or more event notifications 1271, which include some or all of the event description, to the one or more parties to the contract. As further discussed below in relation to FIGS. 14A-B, the parties to the contract can respond to the event notification by verifying the event description or they can choose to dispute the event description, which can lead to an update of the event description.

The performance analysis module 1213 can compare the event description to an individual line item to analyze fulfillment of the corresponding contract. In another embodiment, the event management module 1211 produces a credential corresponding to the event message, via the update credentials process 360 and the record compliance process 370 described above, and the performance analysis module uses the update equipment status process 320 discussed above to compare the credential to a requirement produced by a requirement management module. If the credential is found to conform to the requirement, the obligation of the corresponding contract is considered to be fulfilled.

The performance analysis module 1213 can produce one or more performance measures 1267, which describe an organization's contract performance. Various performance measures can be used with the subject invention and presented to a user of the contract monitoring system 1103.

The performance analysis module 1213 can produce a settlement statement 1265 describing compensation due under a contract based on an organization's performance under the contract. The settlement statement 1265 is an invoice prepared on behalf of one of the contracting parties. The settlement statement 1265 can be produced based on a moderated analysis of contract performance by an unbiased third party. In one embodiment, the settlement statement 1265 is based on an agreed analysis of contract performance, which has been consented to by two or more contracting parties. The settlement statement 1265 can be based on an unbiased analysis of contract performance based on a version of events, which has been consented to by two or more contracting parties.

The resource management module 1205 can produce a resource report 1261 presenting data regarding one or more resources registered with the contract monitoring system 1103. Such data can be summarized or broken down by area, model, class, time period, or other organizational grouping. The resource report 1261 can present data related to resources associated with multiple companies.

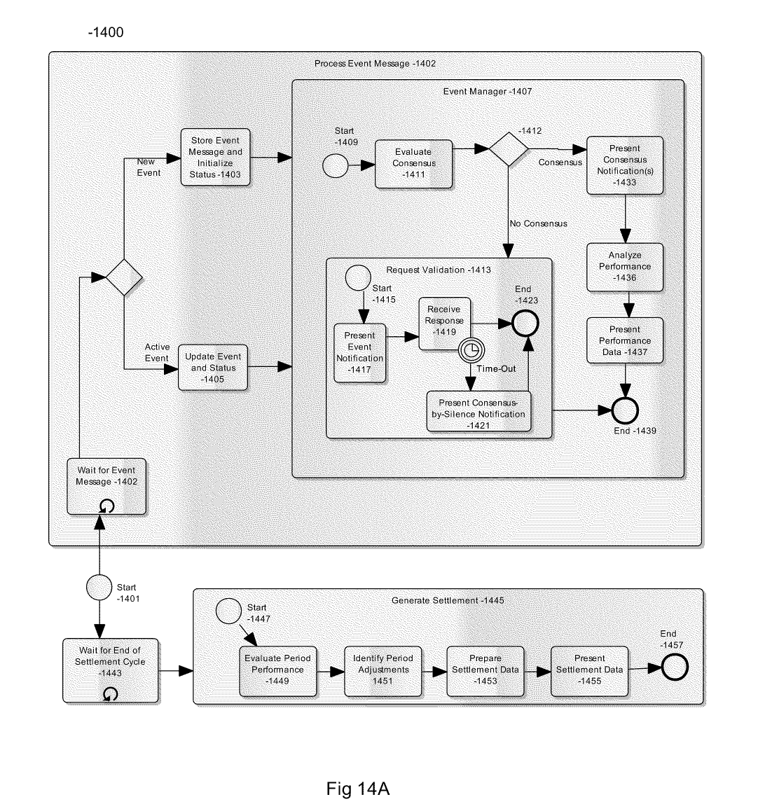

FIG. 13 illustrates a UML class diagram of a contract monitoring system, such as the contract monitoring system 1103. An organization 510 can be associated with zero or more orders 120. Contracts can be broken down into orders and further broken down into line items. In the embodiment shown, contracts are represented by a set of orders 120 and associated line items 165. Individual contracts and orders can also be associated with one or master agreements and SLAs, which can vary or add additional terms to the contract.

Various SLA terms can be described and standardized via SLA options 135. A menu of standard SLAs can be provided. These options can be associated with an area, model, class, or other organizational grouping, or they can be applied globally. In the embodiment shown, an SLA option 135 is associated with zero or more service level agreements 190. Master agreements and SLAs can be associated with sub contracts in various ways. In the embodiment shown, a master agreement 150 describes an ongoing relationship between to contracting parties, and is thus associated with two organizations 510. The master agreement 150 is also associated with one or more service level agreements 190. The service level agreements 190 apply their terms (and the terms of the master agreement 150) to zero or more line items 165. In an alternate embodiment, the terms of a master level agreement 150 and/or service level agreement 190 can be associated at the level of a contract (not shown) or order 120. A group of rental orders can be referred to as a fleet (not shown).

Billing options, which describe how invoices and/or settlement statements are paid under a contract, can be established and varied by various agreements including, but not limited to master agreements, SLAs, contracts, orders, and line items. In the embodiment show, these options can be represented by billing options 130. These options can be associated with an area, model, class, or other organizational grouping, or it can be applied globally. Suppliers normally dictate such billing options. A customer can use billing options 130 to standardize billing practices across multiple contracts with multiple suppliers. In a further embodiment, order and fulfillment practices and data can be similarly standardized.

An organization can have multiple contacts for using or supporting various functions. In the embodiment shown, such contacts are represented by zero or more contacts 598 associated with an organization 510. Contacts 598 can be associated with functions 597 via a function assignment 541. A function 597 can be associated with an area, model, classification, or other organizational grouping. Thus, the contact 598 performs the function 597 for the associated area 520 or other organizational grouping. In the embodiment shown, this relationship is also represented via the function assignment 541. A function can have a global scope, applying to all areas or other organizational groupings. Orders can also be associated with particular organizational areas. Thus, order 120 is associated with area 520. Different organizations can define areas differently. Thus, FIG. 13 shows two separate associations between an order 120 and an area 520.

In the embodiment shown, the order 120 is associated with zero or more line items 165. These line items 165 describe the performance required by the order 120 as varied and augmented by any master agreement 150 and service level agreement 190. A rental order of one or more equipment units 620 is described. Each line item 165 represents a rental company's obligation to supply one equipment unit 620. The terms for delivery and return of the equipment unit can be described by a delivery agreement 175 and a return agreement 176 respectively. In the embodiment shown, each line item 165 is associated with zero or more events 180, which describe events related to the performance required by the line item 165. For an equipment rental contract, events can be associated with equipment units 620 as shown. Each event 180 can also be associated with an event location 115, which describes where the event is to occur (or has occurred). For example, a line item 165 may require that one or more equipment units 620 be dropped off at a particular gate of a worksite. In the embodiment shown, the worksite can be represented by one or more areas 520 and the particular gate can be represented by an event location 115.

In the embodiment shown, each event 180 is associated with one or more event status records 195, which describe status of the performance event. One or more event status records 195 are used to describe whether a required event has occurred and/or how completely the event has been preformed (e.g., partial performance, full performance). One or more event status records 195 are used to describe verification and/or dispute of the event. An event management module, such as the event management module 1211, receives event messages which describe performance events. The event management module creates an event 180 to store such event description. The event management module verifies the event description by sending one or more event notifications to parties to the contract. Such event notifications can be delivered to different party contacts depending on the event type or other information. The contracting parties can affirmatively verify the event description, in which case consensus is reached regarding what has occurred. Failure to affirmatively verify an event description leads to a time-out of the verification process. Such time-out is taken as consent to the event description. Such time-out is taken as a dispute. If a contracting party disputes an event description other parties are given an opportunity to respond. The event description of an event is updated based on such dispute and/or response. An underlying objective is to achieve consensus so that both parties have freely agreed to what has actually occurred in relation to the contract. Various methods of managing events, consensus, and possible disputes are described below with reference to FIGS. 14A and B.

In one embodiment, a performance analysis module, such as the performance analysis module 1213, analyzes the performance events 180 associated with a contract to determine whether the terms of the contract have been fulfilled as agreed. The performance events 180 associated with a line item 165 are compared to the line item to produce zero or more item performance records 151. Thus, the performance analysis module can analyze and store the extent to which each line item 165 has been fulfilled as required. The item performance records 151 are then used to produce various performance measures 125, which describe the performance of an associated organization 510. Performance measures 125 are evaluated over a performance period The performance analysis module also produces a settlement statement 154, which describes compensation due under the relevant contract(s). The settlement statement includes a description of: (a) the performance that was to occur under the terms of the contract(s) (e.g., supplier was to supply a lift for one month); (b) what actually happened (e.g., a lift equipment unit #ABC123 was provided for the entire period); and (c) the agreed to fee for such performance (e.g., $5,000 for the month). To provide desired granularity down to a specific equipment unit 620, a separate settlement statement 154 is generated for each line item 165 corresponding to an equipment unit 620. Multiple settlement statements 154 can then be combined to generate summary settlement statements. For example, a summary settlement statement can be created covering all line items 154 for a particular area 520, performance period, or other organizational grouping. In the embodiment shown, a single line item 165 can be associated with multiple settlement statements 154. This is the case when the line item 165 spans multiple settlement cycles.

In one embodiment, the settlement statement 154 is also based on the evaluation of one or more performance measures 125. Adjustments can be made to the compensation due based on such evaluation. The contract monitoring system can also track payment of such compensation. Such information is described by zero or more payments 152 associated with zero or more settlement statements 154.

The use of a voluntarily agreed to version of events can lead to more credible measures of an organization's performance. A settlement agreement can also be generated based on the parties' consensus as to what has actually occurred in relation to the contract. The settlement statement can include various compensation adjustments based on such consensus. The application of such compensation adjustments can lead to less biased performance reporting and therefore more credible measures of an organization's performance.

Various objects used in an embodiment of a contract monitoring system can also be implemented as subscribable objects, such as functions 597, SLA options 135, and billing options 130, among other objects. Subscriptions to such object definitions can be managed via subscriptions 910 as described above.

FIG. 14A is a flowchart illustrating a method 1400 of managing performance events in accordance with an embodiment of the subject invention. As shown, the method 1400 begins at a starting point 1401. From there the method both waits for a message event to be received at a point 1402 and also waits for the end of a settlement cycle to be reached at a point 1443.

An event message can be received from an organization 510, a rental management system, or a contract management system, among other sources. In one embodiment, the event message is an internal message received from the entity performing the method.

When an event message is received at the point 1402, the method 1400 considers whether the event message describes a new event or one for which an event message has been previously received. If a new event is described in the event message, at a step 1403, the method 1400 stores the event and initializes the event status to reflect the fact that the event has not yet been verified. A contract, order, or line item can be found and associated with the described event. If the event message received at the point 1402 describes an event for which an event message has been previously received the method 1400 proceeds to a step 1405, wherein the stored event and event status are updated to reflect information included in this latest event message. After either step 1403 or step 1405, the method 1400 proceeds to an event manager process 1407, which begins at a starting point 1409.

At a step 1411, the event manager process 1407 evaluates whether consensus has already been established. In an embodiment, this evaluation is based on the event status stored in steps 1403 and/or 1405. If consensus has already been established, it proceeds to a step 1433; if consensus has not already been established, it proceeds to a request validation subroutine 1413.

The request validation subroutine 1413 begins at a starting point 1415. At a step 1417, an event notification is presented to one or more parties to the associated contract. In one embodiment, the event notification is sent to all parties to the associated contract. Where the event message is received from a contracting party, to avoid unnecessary message volume, a corresponding event notification is not sent to such party. At a step 1419, the subroutine 1413 waits for a response to the event notification. When a response is received, the subroutine ends at an ending point 1423 and the response is returned. In one embodiment, the response received has the same general format as the initial event message and therefore can be seamlessly handled by the same processes. In the embodiment shown, if no response is received within a pre-established length of time, the notified parties are deemed to have consented to the event description by their silence. Therefore, the subroutine 1413 proceeds to a step 1421 where a consent-by-silence notification is sent to one or more parties to the associated contract. In one embodiment, the subroutine 1413 also generates an internal response indicating consensus. The subroutine then ends at the ending point 1423 and the response is returned.

If the status at the decision point 1412 indicates the event has been verified (consensus) the process proceeds to a step 1433. In the embodiment shown, at the step 1433, a consensus notification is sent to one or more parties to the associated contract indicating that consensus has been reached regarding the event. In one embodiment, the consent notification is not sent to a party that consented because they are already aware of such consent (e.g., because they consented or because they already received a consent-by-silence notification at the step 1421).

At a step 1436, an organization's performance is analyzed based on the now verified event. Performance can be analyzed by comparing the verified event with an associated line item 165. Zero or more item performance records 151 can be created to store the results of this analysis. In one embodiment, one or more item performance records 151 are considered to generate one or more performance measures 125 for an organization 510. At a step 1437, the resulting performance measures can be presented to a user. Performance measures can be presented in various ways. The process ends at a point 1439.

When the end of a settlement cycle is reached (1443), the method 1400 proceeds to a generate settlement process 1445, which begins at a starting point 1447. In an embodiment, one or more contracts, orders, or line items are found corresponding to the settlement to be generated. At a step 1449, contract performance of one or more parties are evaluated over one or more performance periods associated with the one or more contracts, orders, or line items found. The performance periods evaluated do not necessarily cover the same time period as the settlement cycle.

At a step 1451, any adjustments required by the one or more contracts (including master agreements and SLAs) are identified. At a step 1453, a settlement statement is prepared based on the contracted for compensation and any adjustments. At a step 1455, the settlement statement is presented to a user. The process then ends at a point 1457. The settlement statement can be presented to various parties and in various manners. The statement can be presented to all parties to the contract. In one embodiment, the statement is presented to one or more financial settlement contacts. The statement can be transmitted to one or more contacts via a communication device, such as one of communication devices 71-76.

The use of a consented to version of events can lead to more credible measures of an organization's performance. Moreover, the use of the consented to version of events can leads to the creation of an indisputable invoice (i.e. settlement statement). Settlement statements generated based on the parties' consensus can lead to less biased performance reporting and therefore more credible measures of an organization's performance.

Besides consensus and time-out, various other close conditions can be used to end a dispute process. For example, receiving the same event data from each party, receiving the same event data multiple times or multiple times in series, receiving a large number of event messages regarding the same event, an absolute time-out measured from the time the first event message is received (or the time when the first event notification is sent), the end of a performance period, among other conditions.

FIG. 14B is a flowchart illustrating a generalized method 1471 of managing performance events. The method 1471 can use any or all of the various close conditions discussed above. The method 1471, begins at a step 1473 where an order is received. Such an order can be received, processed, and stored in various ways. At a step 1474, an event message received describing a performance event related to the order. The event message can be received, processes and stored in various ways. Next, a decision point 1475 is reached. If the no event message has yet been received describing the performance event, the method 1471 proceeds to a step 1476 where the event description can be stored and event status initialized as discussed above. Depending on the close condition used, different state information is stored at this time (e.g., the time the event message was received). If the event message is not the first on this topic, the method 1471 proceeds to a step 1477 where the event description and state information can be updated as described above. At a step 1479, a event notification is transmitted or presented as discussed above. Then, at a step 1481, the method 1471 waits for either a close condition to be reached (such as any of the close conditions discussed above) or an event message to be received. When an event message is received, the method 1471 returns to the decision point 1475 as discussed above. When a close condition is reached, the method 1471 proceeds to analyze performance of the order based on the event description then current (1483). Performance data can be presented to a user at this time (1485).

Next, the method 1471 waits for either end of a performance period to be reached or an event message to be received (1487). When an event message is received, the method 1471 returns to the decision point 1475 as discussed above. When the end of a performance period is reached, the method 1471 can proceed to a step 1489. In the embodiment shown, the performance period corresponds to a settlement cycle and a settlement statement is generated and presented to a user (1491) as discussed above.

In one embodiment of the subject invention, the contract monitoring system tracks the performance of the parties to a contact and creates a financial settlement statement for one or more parties based upon the defined contract, any SLAs, any master contracts, and performance. Such a settlement statement an invoice prepared on behalf of one party. The settlement statement can be prepared based on third party direct or indirect third party observations of contract performance. The settlement statement is informed by a verified set of performance events. Performance events are verified by consensus as described above in relation to FIG. 14A. Other methods can be used to verify performance.

The settlement statement can include a description of compensation to be paid by one or more parties based on the defined contract, any SLAs, any master contracts, and performance. Adjustments are made to such compensation based on an evaluation of performance under the contract. Such adjustments are made in accordance with the defined contract, any SLAs, any master contracts, and performance. Adjustments can be separately shown on the settlement statement. In one embodiment, adjustments are consented to by one or more parties to the contract.

Adjustments can be made for a fleet of rental orders over a particular performance period. In a particular embodiment, an SLA can require at least 95% uptime with a 5% penalty (calculated on the total earned revenue during each 3-month period). For example, there may have been 10 rentals with $25,000 of rental fees during a 3-month period where uptime dropped below 95%. The system would generate a settlement statement for the period that includes the appropriate data (e.g., each rental summary, individual performance, individual fees, and total performance and fees). It would also reiterate the SLA requirement and penalty and include the required adjustment. In this case, the total adjusted compensation would be $23,750 based on an adjustment shown of $1,250.

In one embodiment, a performance analysis module or other program module produces one or more performance measures based on the occurrence and/or resolution of one or more events. Various performance measures can be produced by such a module. Such measures can be presented to a user. In one embodiment, such measures are stored for later use. Data tracked or measured as part of performance measures can also lead to a settlement adjustment. Such adjustments can make performance measures more credible by encouraging accurate reporting. In one embodiment, the performance of one or more contracting organizations is considered. The performance of the contract monitoring system or method itself can be measured and reported. Performance measures of a contract monitoring system can be used to debug the system. Some or all of the measures can be tracked, summarized, or broken down by area, model, class, time period, or other organizational grouping. Example measures for an equipment rental contract monitoring system or method are described below. These or analogous measures can be used to monitor other types of contracts.

Uptime Performance. Uptime performance can be defined in various ways. In one embodiment, it is defined as the amount of time a rented equipment unit is in working order divided by the amount of time the equipment unit is contracted for. In a further embodiment, the amount of time contracted for takes into an account pre-established working hours for the equipment unit. Working hours can be established and varied by various agreements including, but not limited to master agreements, SLAs, contracts, orders, and line items. In one embodiment, certain downtime is excused. For example, in an embodiment, downtime is excused if it is not the fault of the supplier. In a further embodiment, such downtime is only excused to the extent of an acceptable resolution time. For example, downtime can be excused if a tire blows because a customer ran over a spike. But the supplier is to fix or replace the tire within an acceptable amount of time of being notified. Otherwise, downtime starts to run again after the acceptable amount of time passes. The acceptable resolution time can be established by industry standard. The acceptable resolution time can be established and/or varied by various agreements including, but not limited to master agreements, SLAs, contracts, orders, and line items. This option can be associated with an area, model, class, or other organizational grouping, or it can be applied globally. Fault for downtime can also be tracked and considered.

Ontime Delivery Performance. Ontime delivery performance can measure how frequently equipment is delivered on time. In other embodiments, ontime delivery performance measures how frequently equipment is delivered by a required data or time or how frequently equipment is delivered within an established delivery window. The delivery window can be established and/or varied by various agreements including, but not limited to master agreements, SLAs, contracts, orders, and line items. This option can be associated with an area, model, class, or other organizational grouping, or it can be applied globally. For example, a contract may require that all bulldozers for a particular project be delivered between 6 AM and 7 AM on the specified delivery date, while all lifts for the project are required to be delivered between 8 AM and 9 AM.

Right Equipment Performance. In One embodiment, right equipment performance measures how frequently the equipment unit delivered matches the equipment unit ordered. As discussed above, the order can specify the equipment by model, class, serial number, or some other indicia. The delivered equipment unit is still usable by the customer the failure is classified as a partial failure. The customer agrees to use the delivered equipment unit until a correct equipment unit is delivered, the failure can be classified as partially resolved until the correct equipment unit is delivered (full resolution). The failure can be classified as having no or negligible customer impact (such as with scheduled maintenance performed during non-work hours).

Service Response Performance Service response performance relates to service issues with rented equipment, as well as the quality of a suppliers response to such issues. Service issues can include equipment failures, maintenance issues, operational questions or concerns, among other equipment issues requiring the supplier's assistance. Various criteria can contribute to service response performance. For example, frequency, severity, impact, fault, and/or type of resolution can be tracked and/or calculated. Frequency can be defined as the number of services issues within a selected time period. Severity can be defined in various ways, such as in terms of one or more time measures. For example, the amount of time to the initial service contact can be tracked. In one embodiment, the amount of time to the initial service contact is the time between when the supplier is first notified of the service issue and when the supplier first contacts the customer regarding the service issue. Similarly, the amount of time to resolution of the service issue can be measured. Both time to partial resolution and time to full resolution can be measured. Impact measures the effect of the service issue on the customer. Service issues can be categorized into partial failures and complete failures. Complete failures make the equipment unusable for its normal use. Partial failures hamper the customer's use of the equipment but not completely. A partial failure can include slowing the equipment down or the loss of some but not all of the equipment functionality. Other categories can be used to categorize service issues. Fault can also be tracked. Some service issues may be caused by a customer but nonetheless require a supplier's attention. Other issues can be caused by a maintenance issue or other responsibility of the supplier. Still other issues may be categorized as neither parties' fault. A company's percentage of fault for service issues can be tracked and contribute to a measure of service response performance. The type of resolution of a service issue can also contribute to such a measure. Like service issues, resolutions of a service issue can be categorized in various. Such resolutions can be categorized into partial or complete (or full) resolutions. Complete resolutions leave the customer with fully functional equipment matching their order. Partial resolutions (like partial failures) leave the customer with useable equipment, but with some issues remaining. For example, the equipment may operate more slowly or with fewer features. Replacing an equipment unit with another unit that does not completely match the customer's order can also be deemed a partial resolution. Other categories can be used to categorize service issue resolutions. For example, the resolution can involve fixing the equipment or replacing the equipment. The service issue can also be canceled.

Dispute Resolution Performance. In one embodiment, dispute resolution performance captures how satisfactorily disputes regarding contract performance are resolved. Various criteria can contribute to dispute resolution performance. Similar to service response performance, the frequency, severity, and/or type of resolution of disputes can be considered. Severity can be defined as the amount of time between the dispute of an event message and the consensus or other final resolution of the dispute. The type of resolution can also categorized and tracked. For example, some disputes are resolved by consensus, others by timeout, some disputes may be considered only partially resolved (e.g., compromise).

Performance Reporting Credibility Performance. In one embodiment, performance reporting credibility performance detects an organization's attempts to unfairly skew other performance measures by underreporting, overreporting, or encouraging others to do so. Various methods can be devised to capture such behavior. In one embodiment, dispute resolution data is considered. For example, the frequency of unresolved disputes can be tracked. In another embodiment, the resolution of disputes is considered. For example, the number of times a disputed event is resolved contrary to a company's initial description of the event can be considered. For example, if a supplier initially indicates that an equipment unit arrived ontime, but later concedes that the equipment unit was an hour late the initial report of the supplier can be considered a performance reporting issue to be counted. Other methods can also be used to track performance reporting credibility performance.

Equipment Abusiveness Performance. Equipment abusiveness performance can capture how hard a customer is on leased resources or equipment. Various methods can be devised to capture such behavior. A customer's percentage of fault for service issues can be considered in this measure. Other methods can also be devised to track this measure.

Payment Timeliness Performance. Payment timeliness performance can capture how quickly an organization pays its bills. Various methods of measuring payment timeliness are well known in the art and can be used with the subject invention. For example, the time between when an invoice or settlement statement is received by an organization and time when payment is received can be tracked. The average number of dollar-days between invoice and payment can be calculated. In one embodiment, the number of days late is considered. In another embodiment, the average number of dollar-days late is calculated. Other data can also be considered as part of this measure. The definition of late can be established and/or varied by various agreements including, but not limited to master agreements, SLAs, contracts, orders, and line items. This option can be associated with an area, model, class, or other organizational grouping, or it can be applied globally.

Billing Accuracy Performance. In one embodiment, billing accuracy performance captures how accurate the invoices or settlement statements prepared by a company are. Where a party to a contract generates an invoice, the accuracy of the invoice is considered. Various methods can be used to capture the accuracy of invoices. In one embodiment, the number or percentage of billing disputes resolved against the party is considered. This information can be captured in the same manner described above with reference to performance reporting creditability performance. Other methods can also be devised to track this measure. Where a contract monitoring system or method generates a settlement statement, the accuracy of the settlement statement can be similarly measured. In one embodiment, the number or percentage of billing disputes resolved against the contract monitoring system is considered.

SOR Compliance Performance. SOR compliance performance can capture how frequently an organization is out of compliance with one or more SORs. Various data can be considered as part of this measure. For example, the number of units in or out of compliance can be tracked. The number of days an equipment unit or an organization is out of compliance can be tracked. In a further embodiment, the number of days an equipment unit is out of compliance divided by the number of days the unit was contracted can be calculated. As discussed above, such data can be summarized or broken down by area, model, class, time period, or other organizational grouping.

Meta Performance Ratings. These ratings combine one or more performance measures. For example, a supplier performance rating can combine performance measures relevant to suppliers; and a customer performance rating can combine performance measures relevant to rental customers. Measures can be combined by averaging. In a further embodiment, a weighted average is used. A user can customize the weights used for the weighted average.

SLA Compliance Performance. SLA compliance performance is a meta performance measure which sets thresholds for other performance measures. If the thresholds are not met SLA compliance performance is affected. SLA compliance performance can be quantified in various ways. In one embodiment, it is the total of monthly SLA penalties incurred by an organization.

A user of a contract monitoring system can vary the way performance data is presented. For example, the data can be sorted, filtered, summarized, among other options. Common spreadsheet application functions are available. Various methods of presenting data are well known in the art can be used with the subject invention. In one embodiment, an option is provided for exporting data to spreadsheet application, a report generating application, or other recognized data format.

An interface between a rental management system and a rental contract management system can be provided. The interface can include various input fields and output fields for some or all of the data described above. Additional data can be input or output via the interface.

The invention requires that data contained within multiple rental company CMSs be transmitted to a central repository. In order for that to happen, it is necessary to define what data is to be transmitted, how that data is to be identified, and the acceptable values for that data. These “data definitions” would include definitions for several pieces of data including: data uniquely identifying the parties to the rental, the contract/order identifier, the equipment requirements (e.g., 40 ft man-lift), dates, delivery location/time, and corresponding rental rates. There would also preferably be definitions that identify the billing cycle, e.g., if it a weekly or monthly billing cycle and whether that cycle begins on the rental date or does it get reset to the 1^{st} of the month.

All of the aforementioned data definitions would correspond to a rental order. A subset of that data would typically make up a delivery confirmation along with some additional data definitions, such as the equipment make, model, year, and unique identifier along with other pertinent data, e.g., date/time/location of actual delivery and whether the equipment was singed for by someone at the site versus left without a written acknowledgement.

Similar data definitions could be used to address an equipment failure, such as the same equipment and/or contract/order identifiers, along with information about the failure. This might include magnitude of the failure (e.g., unusable versus reduced functionality), urgency, date and time reported, contact info for who reported and who is to be the ongoing contact point.

Similar detail would apply to the problem resolution data, invoicing data, and payment data.

Each rental company (or the companies that develop their CMSs) could modify their systems to transmit data complying with the data standard. The would build an Application Program Interface (API) that extracts data from their system's database and passes it along to the API of the current invention.

The system of the subject invention can take the data received from rental companies and present it to rental customers for validation.

### Data Validation

The default (or preferred) mode of operation of the invention involves presenting data to the customer and, unless the customer “disputes” the data within a certain preset time period, the data is considered validated. A customer that does not raise a dispute within the set time period has agrees with the data and gives up any right to dispute the data at a future time, such as during invoicing/financial settlement. If the customer disputes the data, it follows a standard dispute resolution process. This process occurs with each aspect of the rental lifecycle, i.e., the rental order/agreement, the delivery, system failures, system resolutions, off-rent, and off-rent pick-up. This is in contrast to the current rental world where such validation and disputes typically are addressed after the invoice is presented, which is often several weeks after the incident.

### Dispute Resolution

If the customer disagrees with the data, dispute resolution is triggered by, for example, the customer clicking on the website button, reply e-mail, reply text message, etc. The system then sends a notification to the rental company as to the dispute, and then it is up to the rental company to resolve the dispute. Once the company believes that the dispute is resolved, they update the information within their CMS (e.g., correcting the delivery time from 7 am to 10 am) at which point the process returns to its normal flow, i.e., that data is presented to the customer to validate/dispute. If the rental company truly resolved the dispute, then the invention has a log of the original data/dispute and the resolved information. If the dispute is not resolved, the customer again disputes the data.

The system provides a method for standard tracking progress of dissimilar dispute resolution processes across companies. Advantageously, this system provides a low-cost/low administrative approach to validating a rental company's data within their CMS and then using that validated data to produce various useful measures of performance both for at the micro level (e.g., for the two parties to a rental contract) and at the macro-level (to other companies that can use that information to improve their future decision-making).

### Performance Measures

As a result of standardizing the contract and performance data across companies, the system is able to establish measures of company performance as well as rank multiple companies relative to each other based upon performance. Performance measurements can include, for example, uptime (or downtime) performance (a measure of the percent of time that the equipment functions as contracted), failure response time (a measure of the amount of time that it takes a company to resolve broken equipment), a measure of breakdown frequency, data integrity (a measure of how reliably a company reports its data), and composite performance measures. There is also a measure of unresolved disputes. An unresolved dispute occurs when parties are unable to reach an agreement as to the actual data, and tracking such data helps to identify companies that tend to abuse the dispute process. Performance measures exist for the customer, too; therefore, the ratings of a customer that abuses the dispute process (or pays late or underpays) serves as a warning to other rental companies. Likewise, customers might discount the performance ratings of a rental company that has an unusually high frequency of unresolved disputes, so the system has a built-in deterrence to abuse.

Invoice Generation and/or Settlement

The subject invention can create performance-based data that can then be used to generate the invoice—“pre-approved” invoices. The system receives all the data for creating an invoice. It comes from the original order. If that order (or a separate registration/preference process) included information as to a Service Level Agreement (SLA) with financial penalties for non-performance, the information is available to adjust the amounts on the invoice. The invoice is pre-approved

There is an implied review/approval action that is anticipated within a invoicing or billing process that does not apply to the settlement information produced by the invention. The system produces a notification or summary of transactions that have already been reviewed and approved.

In one embodiment, the pre-approved invoice allows for electronic funds transfers to be generated automatically, since the invoice requires no verification or approval. The system of the subject invention can take the dispute process that currently happens at or after invoicing and brings the dispute to coincide with the performance event. Thus, rental companies are able to address performance and customer service issues as they happen rather than learning about them weeks later when it is too late to make a difference.

### Invoice Consolidation and Synchronization

The subject invention can eliminate unsynchronized invoices by allowing the customer to set their own cycle, e.g. weekly, and the rental company continues to be paid on their existing monthly cycles. The system accumulates and holds the weekly payments and then pays the rental companies per their cycles.

The system can eliminate the need for the rental company to produce and transmit invoices. Instead, statements are produced that tell the rental company what they will be paid based upon the combination of what they agreed to provide and what the actually provided. Similar notification can go to the customer regarding what they owe.

All patents, patent applications, provisional applications, and publications referred to or cited herein are incorporated by reference in their entirety, including all figures and tables, to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application.

Many different arrangements of the various components depicted, as well as components not shown, are possible without departing from the spirit and scope of the present invention. Embodiments of the present invention have been described with the intent to be illustrative rather than restrictive. A skilled artisan may develop alternative means of implementing the aforementioned improvements without departing from the scope of the present invention. It will be understood that certain features and subcombinations are of utility and may be employed without reference to other features and subcombinations and are contemplated within the scope of the claims. Not all steps listed in the various figures need be carried out in the specific order described.

It should also be understood that, although the present invention has been described with reference to specific details of certain embodiments thereof, it is not intended that such details should be regarded as limitations upon the scope of the invention except as and to the extent that they are included in the accompanying claims.

I claim:

1. A method for improving the allocation of physical assets of an organization by:
a) monitoring contract performance of multiple entities,
b) creating one or more performance measures reflective of the contract performance for the multiple entities, and
c) providing the organization with access to the performance measures such that, based on the performance measures, the organization improves its allocation of physical assets, and wherein said method further comprises, for multiple contracts,
i) receiving a requirement description, wherein the requirement description comprises data describing an obligation of an obligor under a contract;
ii) receiving an event message from a first party to the contract, wherein the event message comprises data describing the performance of the obligation;
iii) analyzing performance under the contract based on the requirement description and the event message;
iv) producing at least one performance measure based on the analysis; and
v) presenting the performance measure(s) to the organization;
and wherein, based on the performance measure(s), the organization improves its allocation of physical assets.

2. The method, according to claim 1, wherein the organization that improves its asset allocation is an equipment rental company or a renter of equipment.

3. The method, according to claim 2, wherein based on the performance measure(s), the organization improves its physical asset allocation by renting more or less equipment and/or by renting different equipment than it would have otherwise.

4. The method, according to claim 2, wherein the organization is a rental company and, as a result of the performance measure(s), the organization acquires and/or disposes of equipment in order to improve asset allocation.

5. The method, according to claim 2, wherein the organization is a rental company and, as a result of the performance measure(s), the organization alters its procedures for serving the equipment.

6. The method, according to claim 2, wherein the organization is a rental company and, as a result of the performance measure(s), the organization changes the location where equipment is stored.

7. The method, according to claim 2, wherein, as a result of the performance measure(s), the organization changes the procedure by which equipment is delivered and/or returned.

8. The method, according to claim 1, wherein, as a result of the performance measure(s), the organization changes how, when, and/or where equipment is operated.

9. The method, according to claim 1, wherein, as a result of the performance measure(s), the organization changes its procedures for dispute resolution and/or invoicing.

10. The method of claim 1, which is implemented through the use of a suitably programmed computer.

11. A method of administering a service contract between at least two parties, comprising:
receiving contract terms for a service contract;
generating a contract record based on said contract terms;
storing the contract record;
receiving event information, wherein the event information comprises information related to the performance of an obligation required by the service contract;
storing the event information;
transmitting an event notification to one party, wherein the event notification is based on the event information related to the performance of the obligation; and
transmitting the event notification to the other party.

12. The method, according to claim 11, which further comprises:
receiving a notice from a party wherein the notice provides notification that the event notification is disputed;
resolving the dispute over the event notification;
and storing a dispute record.

13. The method, according to claim 12, which further comprises:
generating a settlement statement based on the event information, including the dispute record; and
transmitting the settlement statement to at least one of the parties.

14. The method, according to claim 13, which further comprises receiving payment, or information regarding payment, of the settlement statement.

15. The method, according to claim 14, further comprising generating a performance rating based on the payment information, the event information, and the dispute record.

16. A computer-readable medium having computer-useable instructions embodied thereon for monitoring at least one contract, wherein the instructions cause a computer-system to perform the following steps:
providing a requirement management module, a database, an event module, and a notification module;
receiving in the requirement management module a contract requirement description, wherein the requirement description comprises data describing an obligation of an obligor under the contract;
generating, in the requirement management module, a requirement record based on the contract requirement description;
storing the requirement record in the database;
receiving in the event module an event message from an obligee to the contract, wherein the event message comprises data describing the performance of the obligation;
storing the event message in the database;
analyzing in the event module performance under the contract based on the requirement description and the event message and
transmitting, via the notification module, an event notification, wherein the event notification comprises information related to the performance of the obligation.

17. The medium of claim 16, wherein the instructions further cause the computer-system to perform the following steps:
providing a dispute module;
receiving a notice from the obligor or the obligee, wherein the notice provides notification that the event notification is disputed;
resolving, in the dispute module, the dispute over the event notification;
updating the event information in the database; and
storing a dispute record in the database.

18. The medium of claim 17, wherein the instructions further cause the computer-system to perform the following steps:
providing a rating module;
receiving payment information regarding performance of a payment obligation required by the contract,
generating a performance rating based on the payment information, the event information, and the dispute record; and
transmitting the performance rating to a potential customer.

19. The medium of claim 16, wherein the instructions further cause the computer-system to perform the following steps:
generating, in a settlement module, a settlement statement based on the contract record and the event information; and
transmitting the settlement statement to the obligor and/or the obligee.

20. The medium of claim 19, wherein the instructions further cause the computer-system to perform the following steps:
receiving a payment; and
transmitting funds to the obligor or obligee based on the settlement statement.

21. The medium of claim 20, wherein the instructions further cause the computer-system to perform the following step:
presenting via a web server the contract record, the event notification, the settlement statement, and the performance rating.

22. A computer-readable medium having computer-useable instructions embodied thereon for administering a contract between parties to the contract, wherein the instructions cause a computer-system to perform the steps comprising:
providing a contract module, a database, an event module, and a notification module;
receiving, in the contract module, terms for the contract;
generating, in the contract module, a contract record based on the contract terms;
storing the contract record in the database;
receiving, in the event module, event information, wherein the event information comprises information related to the performance of an obligation required by the contract;
storing the event information in the database;
transmitting, via the notification module, an event notification to one or more of the parties to the contract, wherein the event notification comprises information related to the performance of the obligation; and
transmitting, via the notification module, the event notification to one or more of the parties.

23. The medium of claim 22, wherein the instructions further cause the computer-system to perform the following steps:
providing a dispute module;
receiving a notice from a party, wherein the notice comprises a notification that the event notification is disputed;
resolving, in the dispute module, the dispute over the event notification;
changing the event information in the database; and
storing a dispute record in the database.

24. The medium of claim 22, wherein the instructions further cause the computer-system to perform the following steps:
providing a rating module;
receiving payment information regarding performance of a payment obligation required by the contract,
generating a performance rating based on the payment information, the event information, and the dispute record; and
transmitting the performance rating to a potential customer.

25. The medium of claim 24, wherein the instructions further cause the computer-system to perform the following steps:
generating, in a settlement module, a settlement statement based on the contract record and the event information; and
transmitting the settlement statement to one or more of the parties.

26. The medium of claim 25, wherein the instructions further cause the computer-system to perform the following steps:
receiving a payment from a party; and
transmitting funds to a party based on the settlement statement.

27. The medium of claim 26, wherein the instructions further cause the computer-system to perform the following step:
presenting via a web server the contract record, the event notification, the settlement statement, and the performance rating.

28. A system for monitoring at least one contract comprising:
a requirement management module, wherein the requirement management module receives a contract registration message describing a contract and produces a requirement record corresponding to an obligation under the contract;
an event management module, wherein the event management module receives an event message describing performance of the obligation under the contract and produces a credential record corresponding to the event message; and
a performance analysis module, wherein the performance analysis module compares the credential record to the requirement record to evaluate performance under the contract.

29. A method of administering multiple service contracts that a renter of equipment has with multiple equipment rental companies, comprising:
receiving contract terms for multiple service contracts;
generating a contract record for each of the multiple contracts, based on said contract terms;
storing the contract records;
receiving event information, wherein the event information comprises information related to the performance of an obligation required by one of the service contracts;
storing the event information;
transmitting an event notification to one party, wherein the event notification is based on the event information related to the performance of the obligation;
transmitting the event notification to the other party;
optionally, generating a settlement statement based on the event information;
creating a report that shows information for all of the multiple service contracts; and
transmitting the report, or otherwise making the report accessible to, the renter.

30. The method, according to claim 29, wherein the report provides the following information:
i) identification of rental companies with which the renter has contracts;
ii) identification of the equipment rented;
iii) event notifications;
iv) information about any disputes; and
v) settlement information.

31. The method, according to claim 29, which further facilitates financial settlement of amounts due under the contracts, and wherein said settlement is facilitated by one or more of the following:
i) consolidation of the amounts owed under multiple contracts;
ii) synchronization of billing cycles for multiple contracts; and
iii) collecting funds due under multiple contracts and distributing the appropriate amounts, at appropriate times, to payees.
